(19) United States
(12) Patent Application Publication
(10) Pub. No.: US 2013/0081020 A1
(43) Pub. Date: Mar. 28, 2013

(54) Receiving discrete interface device subtask result data and acquiring task result data

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Delaware

(21) Appl. No.: 13/374,522

(22) Filed: Dec. 30, 2011

Related U.S. Application Data
(63) Continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation-in-part of application No. 13/317,591, filed on Oct. 21, 2011.
Application No. 13/317,591 is a continuation-in-part of application No. 13/317,833, filed on Oct. 28, 2011.
Application No. 13/317,833 is a continuation-in-part of application No. 13/373,795, filed on Nov. 29, 2011.
Application No. 13/373,795 is a continuation-in-part of application No. 13/373,794, filed on Nov. 29, 2011.
Application No. 13/373,794 is a continuation-in-part of application No. 13/373,826, filed on Nov. 30, 2011.
Application No. 13/373,826 is a continuation-in-part of application No. 13/373,829, filed on Nov. 30, 2011.
Application No. 13/373,829 is a continuation-in-part of application No. 13/374,512, filed on Dec. 30, 2011.
Application No. 13/374,512 is a continuation-in-part of application No. 13/374,514, filed on Dec. 30, 2011.
Application No. 13/374,514 is a continuation-in-part of application No. 13/374,529, filed on Dec. 30, 2011.
Application No. 13/374,529 is a continuation-in-part of application No. 13/374,527, filed on Dec. 30, 2011.
Application No. 13/374,527 is a continuation-in-part of application No. 13/374,511, filed on Dec. 30, 2011.
Application No. 13/374,511 is a continuation-in-part of application No. 13/374,518, filed on Dec. 30, 2011.

(51) Int. Cl. G06F 9/46

(52) U.S. Cl. 718/100

(57) ABSTRACT

Computationally implemented methods and systems include transmitting one or more subtasks corresponding to at least a portion of one or more tasks of acquiring data requested by a task requestor to a plurality of discrete interface devices, obtaining subtask result data corresponding to a result of the one or more subtasks carried out by two or more discrete interface devices of the plurality of discrete interface devices in an absence of information regarding the task of acquiring data and/or the task requestor, and acquiring task result data corresponding to a result of the task of acquiring data using the obtained subtask result data and information regarding the two or more discrete interface devices from which the subtask result data is obtained. In addition to the foregoing, other aspects are described in the claims, drawings, and text.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,591, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/317,833, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 28, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,795, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,794, entitled METHODS AND DEVICES FOR RECEIVING AND EXECUTING SUBTASKS, naming Royce A. Levien; Richard T. Lord; Robert W. Lord; Mark A. Malamud; and John D. Rinaldo, Jr., as inventors, filed Nov. 29, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,826, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/373,829, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Nov. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled ACQUIRING TASKS AND SUBTASKS TO BE CARRIED OUT BY INTERFACE DEVICES, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled ACQUIRING AND TRANSMITTING TASKS AND SUBTASKS TO INTERFACE DEVICES, AND OBTAINING RESULTS OF EXECUTED SUBTASKS, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled ACQUIRING AND TRANSMITTING TASKS AND SUBTASKS TO INTERFACE DEVICES, AND OBTAINING RESULTS OF EXECUTED SUBTASKS, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. ______, entitled RECEIVING SUBTASK REPRESENTATIONS, AND OBTAINING AND COMMUNICATING SUBTASK RESULT DATA, naming Royce A. Levien; Richard T. Lord; Robert W. Lord; Mark A. Malamud; and John D. Rinaldo, Jr., as inventors, filed Dec. 30, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to transmitting one or more subtasks corresponding to at least a portion of one or more tasks of acquiring data requested by a task requestor to a plurality of discrete interface devices, obtaining subtask result data corresponding to a result of the one or more subtasks carried out by two or more discrete interface devices of the plurality of discrete interface devices in an absence of information regarding the task of acquiring data and/or the task requestor, and acquiring task result data corresponding to a result of the task of acquiring data using the obtained subtask result data and information regarding the two or more discrete interface devices from which the subtask result data is obtained. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein referenced method aspects depending upon the design choices of the system designer.

A computationally implemented system includes, but is not limited to means for transmitting one or more subtasks corresponding to at least a portion of one or more tasks of acquiring data requested by a task requestor to a plurality of discrete interface devices, means for obtaining subtask result data corresponding to a result of the one or more subtasks carried out by two or more discrete interface devices of the plurality of discrete interface devices in an absence of information regarding the task of acquiring data and/or the task requestor, and means for acquiring task result data corresponding to a result of the task of acquiring data using the obtained subtask result data and information regarding the two or more discrete interface devices from which the subtask result data is obtained. In addition to the foregoing, other system aspects are described in the claims, drawings, and text forming a part of the present disclosure.

A computationally implemented system includes, but is not limited to circuitry for transmitting one or more subtasks corresponding to at least a portion of one or more tasks of acquiring data requested by a task requestor to a plurality of discrete interface devices, circuitry for obtaining subtask result data corresponding to a result of the one or more subtasks carried out by two or more discrete interface devices of the plurality of discrete interface devices in an absence of information regarding the task of acquiring data and/or the task requestor, and circuitry for acquiring task result data corresponding to a result of the task of acquiring data using the obtained subtask result data and information regarding the two or more discrete interface devices from which the subtask result data is obtained.

A computer program product comprising an article of manufacture bears instructions including but not limited to one or more instructions for transmitting one or more subtasks corresponding to at least a portion of one or more tasks of acquiring data requested by a task requestor to a plurality of discrete interface devices, one or more instructions for obtaining subtask result data corresponding to a result of the one or more subtasks carried out by two or more discrete interface devices of the plurality of discrete interface devices in an absence of information regarding the task of acquiring data and/or the task requestor, and one or more instructions for acquiring task result data corresponding to a result of the task of acquiring data using the obtained subtask result data and information regarding the two or more discrete interface devices from which the subtask result data is obtained.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2, including FIGS. 2A-2C, shows a particular perspective of one or more subtasks corresponding to at least a portion of one or more requested tasks of acquiring data subtask transmitting module 52 of the computing device 30 of environment 100 of FIG. 1.

FIG. 3, including FIGS. 3A-3C, shows a particular perspective of the absent information two-or-more discrete interface device subtask result data obtaining module 54 of the computing device 30 of environment 100 of FIG. 1.

FIG. 4, including FIGS. 4A-FG, shows a particular perspective of the received subtask data and information regarding discrete interface devices-based task result data acquiring module 56 of the computing device 30 of environment 100 of FIG. 1.

FIG. 5 is a high-level logic flowchart of a process, e.g., operational flow 500, according to an embodiment.

FIG. 6A is a high-level logic flowchart of a process depicting alternate implementations of a transmitting one or more subtasks corresponding to at least a portion of one or more tasks of acquiring data requested by a task requestor to a plurality of discrete interface devices operation 502 of FIG. 5.

FIG. 6B is a high-level logic flowchart of a process depicting alternate implementations of a transmitting one or more subtasks corresponding to at least a portion of one or more tasks of acquiring data requested by a task requestor to a plurality of discrete interface devices operation 502 of FIG. 5.

FIG. 6C is a high-level logic flowchart of a process depicting alternate implementations of a transmitting one or more subtasks corresponding to at least a portion of one or more tasks of acquiring data requested by a task requestor to a plurality of discrete interface devices operation 502 of FIG. 5.

FIG. 6D is a high-level logic flowchart of a process depicting alternate implementations of a transmitting one or more subtasks corresponding to at least a portion of one or more tasks of acquiring data requested by a task requestor to a plurality of discrete interface devices operation 502 of FIG. 5.

FIG. 7A is a high-level logic flowchart of a process depicting alternate implementations of an receiving subtask result data corresponding to a result of the one or more subtasks operation 504 of FIG. 5.

FIG. 7B is a high-level logic flowchart of a process depicting alternate implementations of an receiving subtask result data corresponding to a result of the one or more subtasks carried out by two or more discrete interface devices of the plurality of discrete interface devices in an absence of information regarding the task of acquiring data and/or the task requestor operation 504 of FIG. 5.

FIG. 7C is a high-level logic flowchart of a process depicting alternate implementations of an receiving subtask result data corresponding to a result of the one or more subtasks carried out by two or more discrete interface devices of the plurality of discrete interface devices in an absence of information regarding the task of acquiring data and/or the task requestor operation 504 of FIG. 5.

FIG. 7D is a high-level logic flowchart of a process depicting alternate implementations of an receiving subtask result data corresponding to a result of the one or more subtasks carried out by two or more discrete interface devices of the plurality of discrete interface devices in an absence of information regarding the task of acquiring data and/or the task requestor operation 504 of FIG. 5.

FIG. 7E is a high-level logic flowchart of a process depicting alternate implementations of an receiving subtask result data corresponding to a result of the one or more subtasks carried out by two or more discrete interface devices of the plurality of discrete interface devices in an absence of information regarding the task of acquiring data and/or the task requestor operation 504 of FIG. 5.

FIG. 7F is a high-level logic flowchart of a process depicting alternate implementations of an receiving subtask result data corresponding to a result of the one or more subtasks carried out by two or more discrete interface devices of the plurality of discrete interface devices in an absence of information regarding the task of acquiring data and/or the task requestor operation 504 of FIG. 5.

FIG. 8A is a high-level logic flowchart of a process depicting alternate implementations of an acquiring task result data operation 506 of FIG. 5.

FIG. 8B is a high-level logic flowchart of a process depicting alternate implementations of an acquiring task result data operation 506 of FIG. 5.

FIG. 8C is a high-level logic flowchart of a process depicting alternate implementations of an acquiring task result data operation 506 of FIG. 5.

FIG. 8D is a high-level logic flowchart of a process depicting alternate implementations of an acquiring task result data operation 506 of FIG. 5.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

In addition, the promulgation of portable electronic devices, each having their own set of unique sensors and detectors, has been widespread. Currently, there are very few populated areas of developed countries that do not contain a large number of portable computing devices at any given time. These portable computing devices are constantly collecting data, and capable of collecting data, which is not stored in any repository or transmitted to any device that may use such data. Thus, such data, and opportunity to collect data, may be lost.

In accordance with various embodiments, computationally implemented methods, systems, and articles of manufacture are provided for transmitting one or more subtasks corresponding to at least a portion of one or more tasks of acquiring data requested by a task requestor to a plurality of discrete interface devices, obtaining subtask result data corresponding to a result of the one or more subtasks carried out by two or more discrete interface devices of the plurality of discrete interface devices in an absence of information regarding the task of acquiring data and/or the task requestor, and acquiring task result data corresponding to a result of the task of acquiring data using the obtained subtask result data and information regarding the two or more discrete interface devices from which the subtask result data is obtained.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

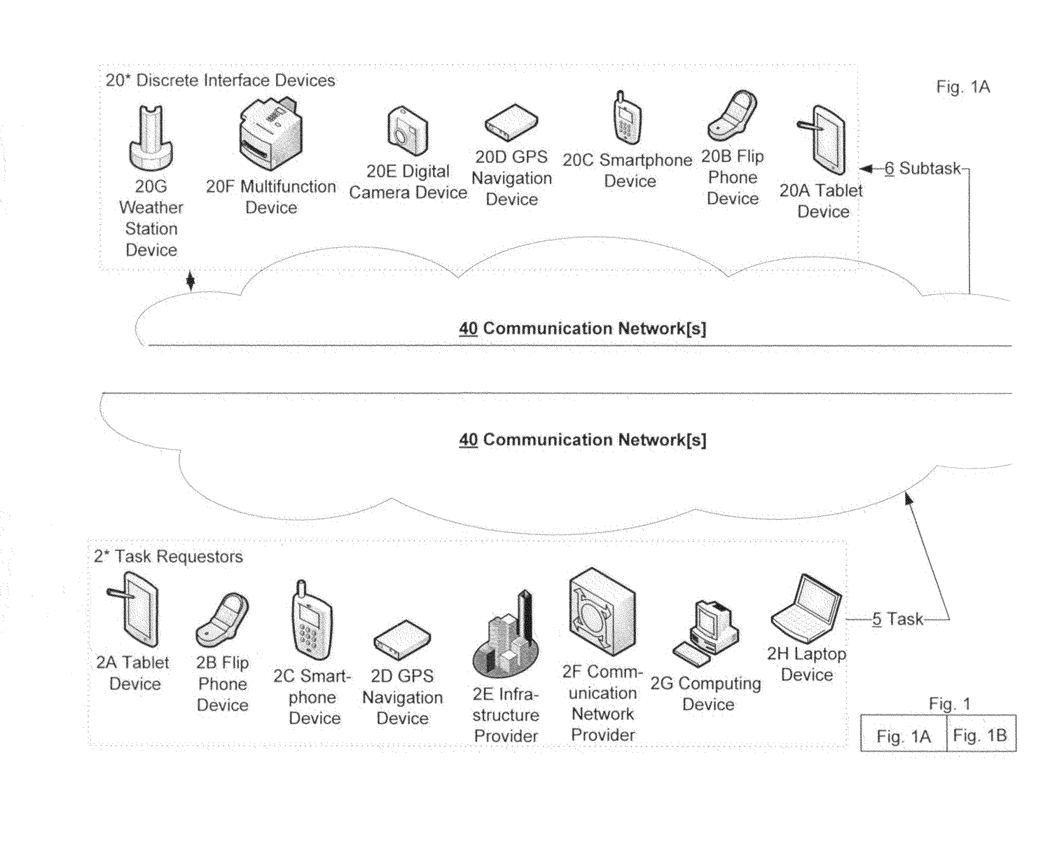

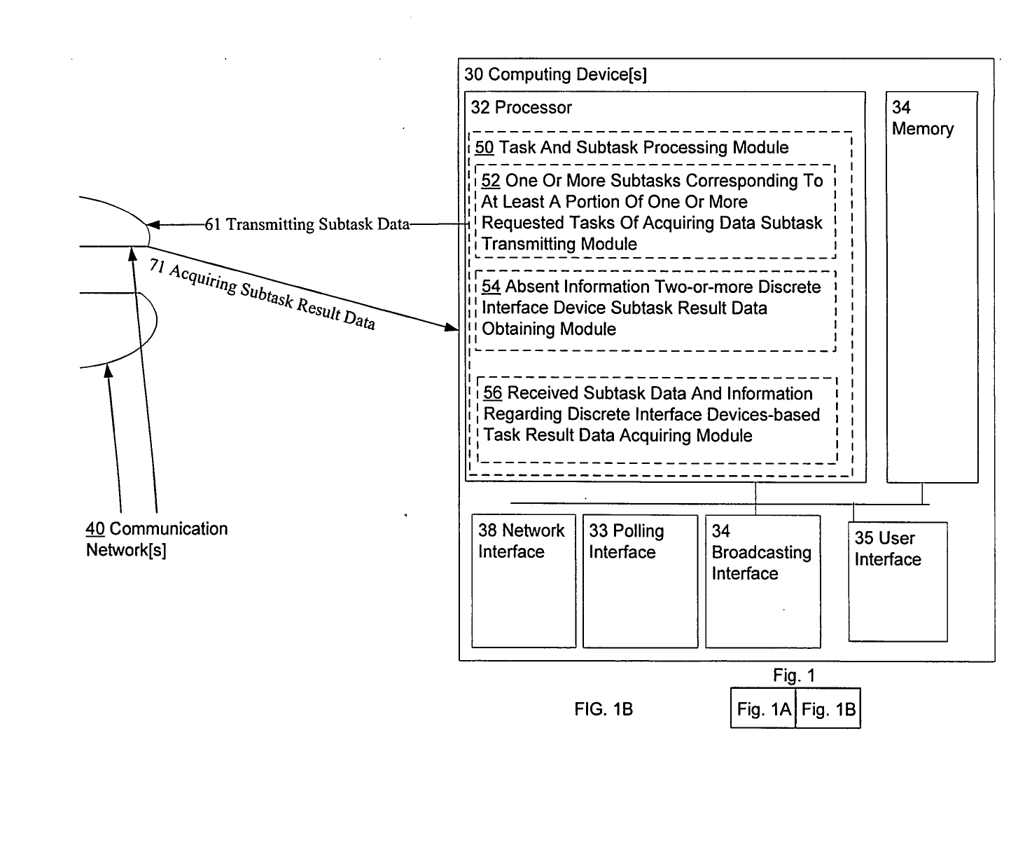

Referring now to FIG. 1, FIG. 1 illustrates a computing device 30 in an exemplary environment 100. As will be described in more detail herein, the computing device 30 may employ the computationally implemented methods, systems, and articles of manufacture in accordance with various embodiments. The computing device 30, in various embodiments, may be endowed with logic that is designed to acquire one or more subtasks that correspond to portions of a task of acquiring data requested by a task requestor, wherein the task of acquiring data is configured to be carried out by two or more discrete interface devices, transmit at least one of the one or more subtasks to at least two of the two or more discrete interface devices, wherein the one or more subtasks are configured to be carried out in an absence of information regarding the task requestor and/or the task of acquiring data, and receive result data corresponding to a result of an executed one or more subtasks

Note that in the following description, the character “*” represents a wildcard. Thus, references to, for example, task requestors 2* of FIG. 1 may be in reference to tablet device 2A, flip phone device 2B, smartphone device 2C, GPS navigation device 2D, infrastructure provider 2E, communication network provider 2F, computing device 2G, laptop device 2H, which may be part of computing device 30, but for the purposes of the interface devices described herein, is not distinguishable from the other task requestors 2*. FIG. 1 illustrates a number of task requestors 2*. For example, FIG. 1 illustrates task requestor 2A as a tablet, task requestor 2B as a flip phone, and task requestor 2C as a smartphone device. These drawings are meant to be illustrative only, and should not be construed as limiting the definition of task requestors 2*, which can be any device with computing functionality.

Similarly, interface devices 20* of FIG. 1 may be in reference to tablet device 20A, flip phone device 20B, smartphone device 20C, GPS navigation device 20D, digital camera device 20E, multifunction device 20F, and weather station device 20G. These drawings are meant to be illustrative only, and should not be construed as limiting the definition of interface devices 20*, which can be any device with computing functionality.

Within the context of this application, “discrete interface device” is defined as an “interface device capable of operating or being operated independently of other discrete interface devices.” The discrete interface devices may be completely unaware of each other, and are not necessarily the same type. For example, discrete interface devices 20*, which will be described in more detail herein, include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

Referring again to the exemplary environment 100 of FIG. 1, in various embodiments, the task requestors 2 may send a task, e.g., task 5 to computing device 30. Computing device 30 may be any type of device that has a processor and may communicate with other devices. Although FIG. 1 illustrates computing device 30 as a single unit, computing device 30 may be implemented as multiple computers, servers, or other devices, operating singularly or in parallel, connected locally or via any type of network. As shown in FIG. 1, computing device 30 is illustrated as having several modules that will be discussed in more detail herein. Specifically, these particular modules may be implemented across different networks and systems, and may be partially or wholly unaware of each other, except for the need to transmit data as indicated by the arrows within computing device 30.

A task 5 sent from a task requestor 2* may be received by computing device 30, and separated into its component subtasks. In other embodiments, a task 5 sent from a task requestor 2* may be received by another computing device (not shown), and separated into its component subtasks, which then may be sent to computing device 30. In some embodiments, the another computing device may rely on partial human intervention to be separated into its component subtasks. In other embodiments, the another computing device may be entirely automated, and may use such techniques as are known in the art to separate tasks into subtasks. Tasks may be separated into component subtasks using any known type of processing, including neural net processing, natural language processing, machine learning, logic-based processing, and knowledge-based processing. For example, a received task may be “Take a 360 degree picture of the Eiffel Tower.” The subtask acquiring module 32 may process the language of this received task, and separate it into components of “take a picture of the Eiffel Tower.” Either by consulting machine archives or by predicting how many pictures must be combined to make a 360 degree picture, the system may determine, for example, that 25 pictures of the Eiffel Tower are needed. These twenty-five “take a picture of the Eiffel Tower” subtasks thus are created. The preceding example is merely a simple example of how a computing device 30 may process tasks into subtasks. Other methods, which may be substantially more complex, may be used in this process, but are not discussed in detail here.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other. It is further noted, that, in this drawing, communication network 40 is shown having a split between the task requestors 2* and the discrete interface devices 20*. This is because, in embodiments, the discrete interface devices 20* cannot communicate with the task requestors 2*. As will be discussed in more detail herein, the discrete interface devices 20* operate with a smaller subset of information than what is available to task requestors 2* regarding the nature of the task and/or the task requestor, e.g., discrete interface devices 20* operate in an “absence of information regarding the task and/or the task requestor.”

Computing device 30 may include a network interface module 38 to facilitate communications with communications network 40. Network interface module 38, which may be implemented as hardware or software, or both, used to interface the computing device 30 with the one or more communication networks 40. In some embodiments, the network interface module 38 may be a Network Interface Card, e.g., a NIC, or an antenna. The specific structure of network interface module 38 depends on the type or types of one or more communication networks 40 that are used. Particular details of this transmission will be discussed in more detail herein.

Computing device 30 also may include a polling interface 33 and a broadcasting interface 34, which also may interface with communications network 40. Polling interface 33 and broadcasting interface 34 also may be implemented as hardware or software, or both, and may share component parts and/or machine-readable instructions with network interface module 38. In some embodiments, the same hardware and/or software is used to implement network interface 38, polling interface 33, and broadcasting interface 34. The specific functions of these devices will be discussed in more detail herein with respect to the modules and computationally-implemented methods described herein.

As shown in FIG. 1, computing device 30 may transmit subtask data 61 to discrete interface devices, either directly, or through an intermediary (not shown). Further, computing device 30 may receive subtask result data 71 through a variety of communication formats. As will be described in more detail herein, the subtask result data is used to acquire result data for a task.

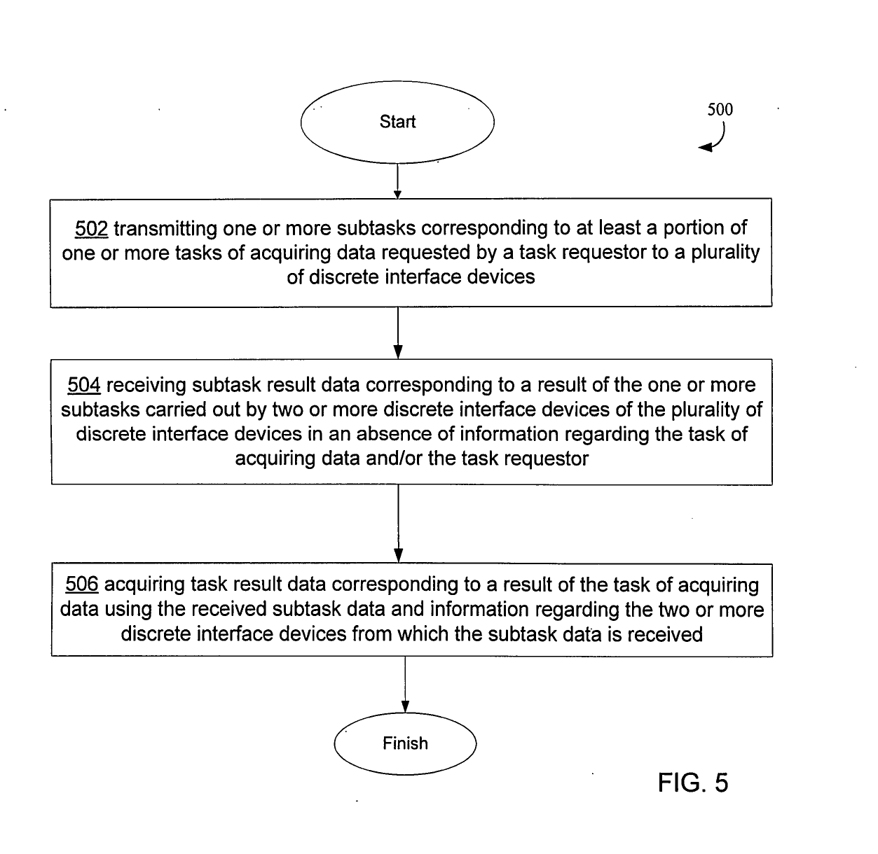

Referring again to the example environment 100 of FIG. 1, in various embodiments, the computing device 30 may comprise, among other elements, a processor 32, a memory 34, and a user interface 35. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5A-5C, 6A-6E, and 7A-7G. In some embodiments, processor 32 is designed to be configured to operate as the subtask module 50, which may include task portion two-or-more discrete interface device subtask acquiring module 52, absent knowledge of task and/or task requestor information subtask transmitting module 54, and executed subtask result data receiving module 56.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

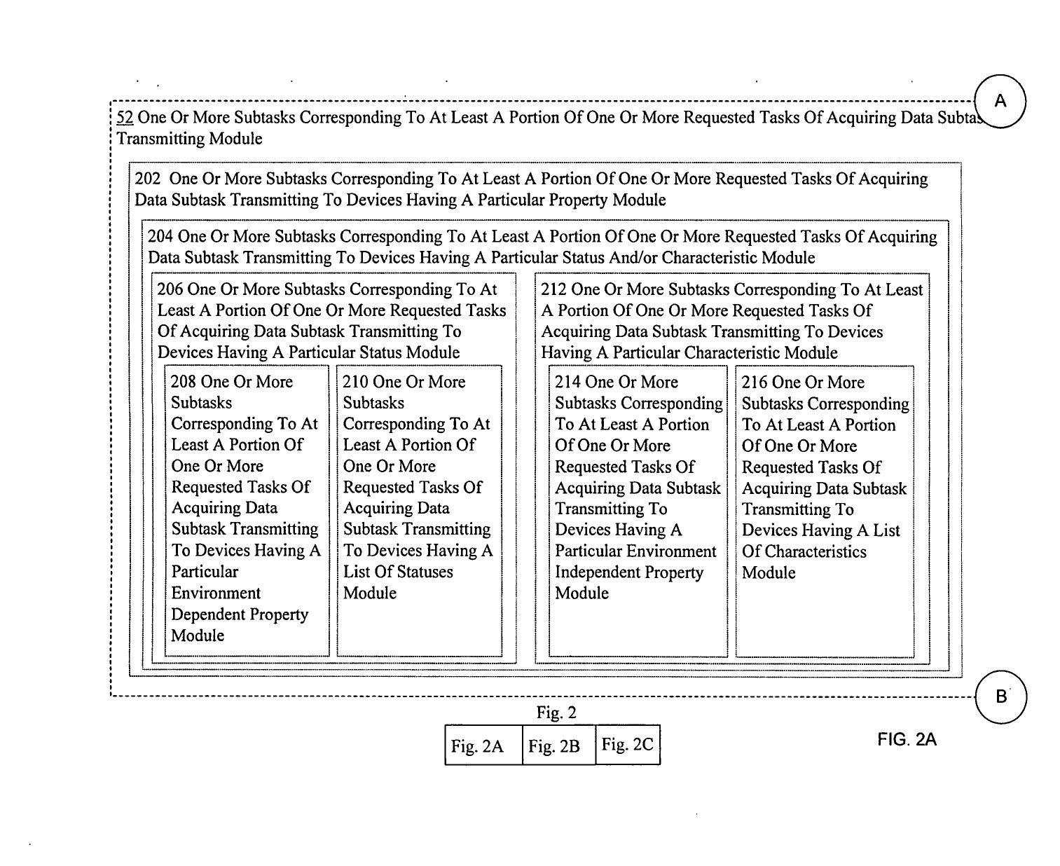

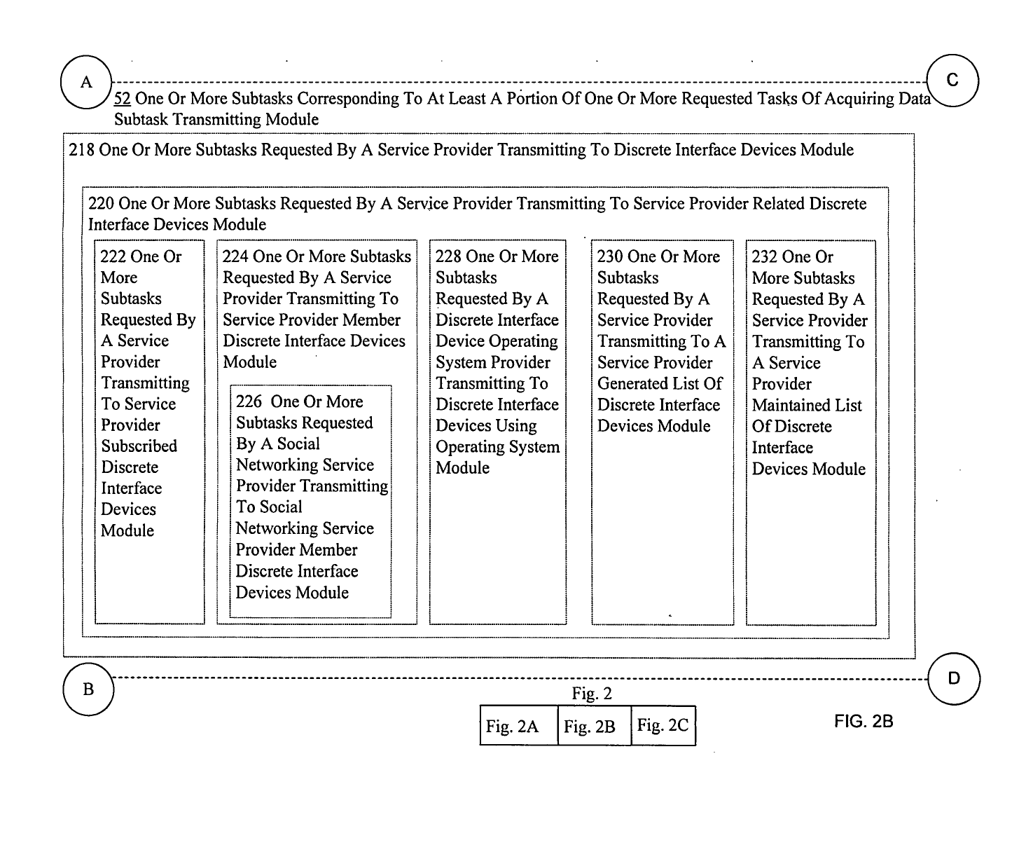

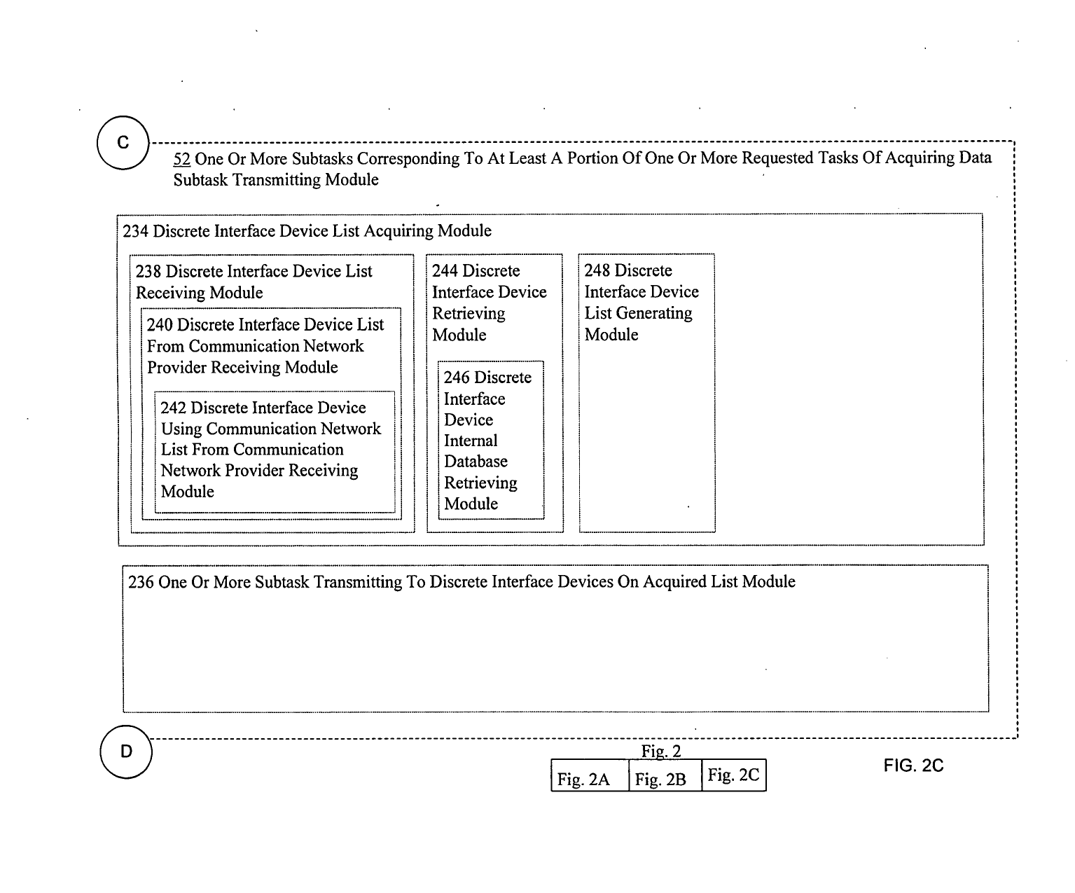

Referring now to FIG. 2, FIG. 2 illustrates an exemplary implementation of the one or more subtasks corresponding to at least a portion of one or more requested tasks of acquiring data subtask transmitting module 52 of module 50. As illustrated in FIG. 2, the one or more subtasks corresponding to at least a portion of one or more requested tasks of acquiring data subtask transmitting module 52 may include one or more sub-logic modules in various alternative implementations and embodiments. These modules will be discussed in more detail herein with respect to the corresponding methods executed by the various logic and sub-logic modules.

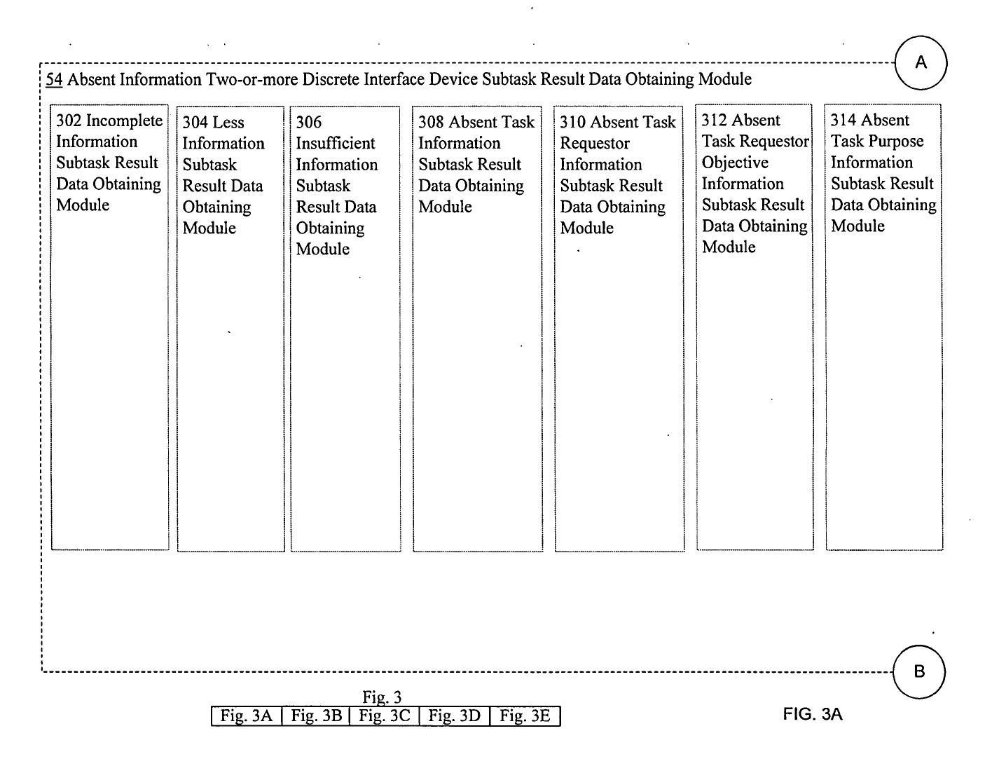

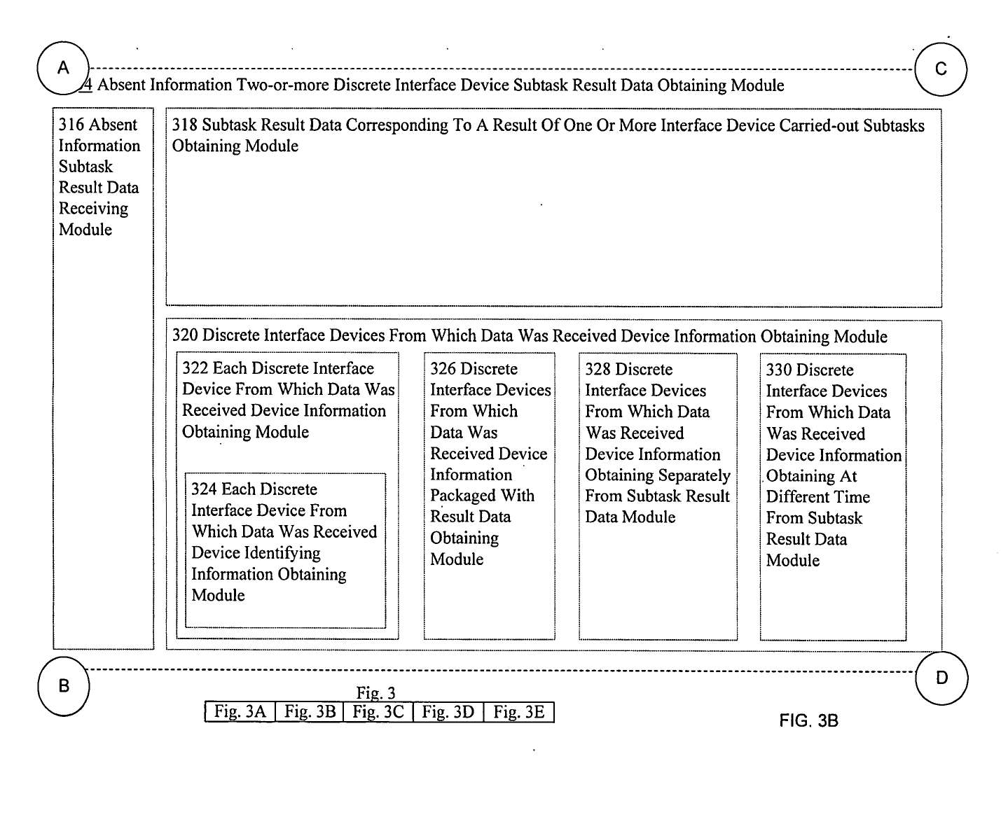

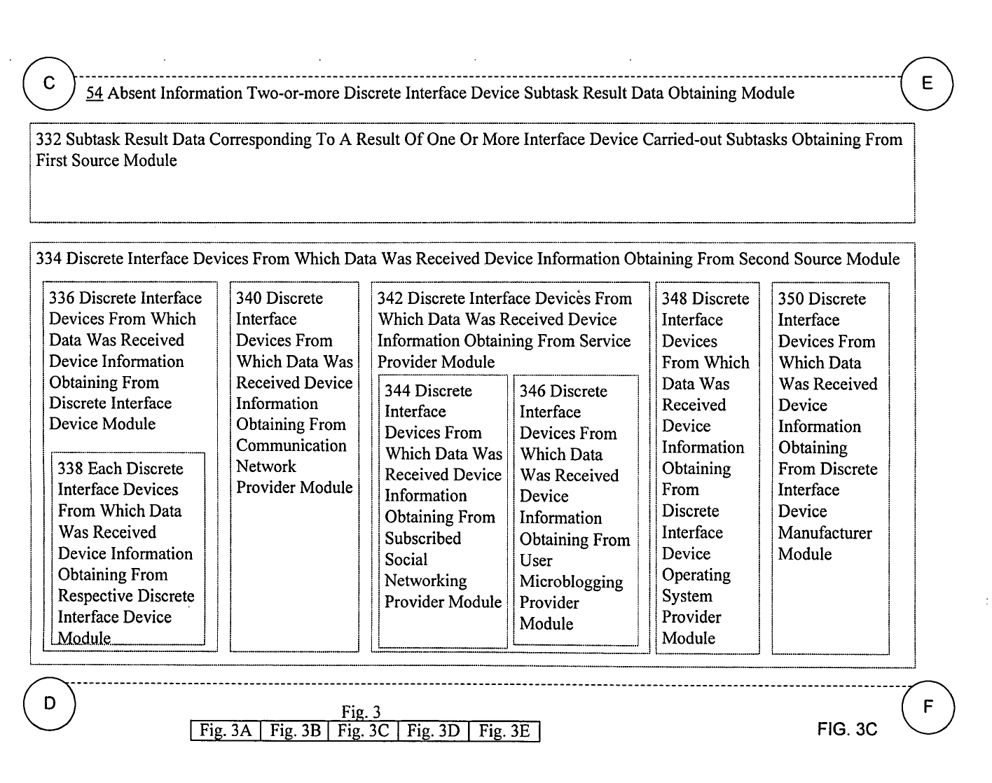

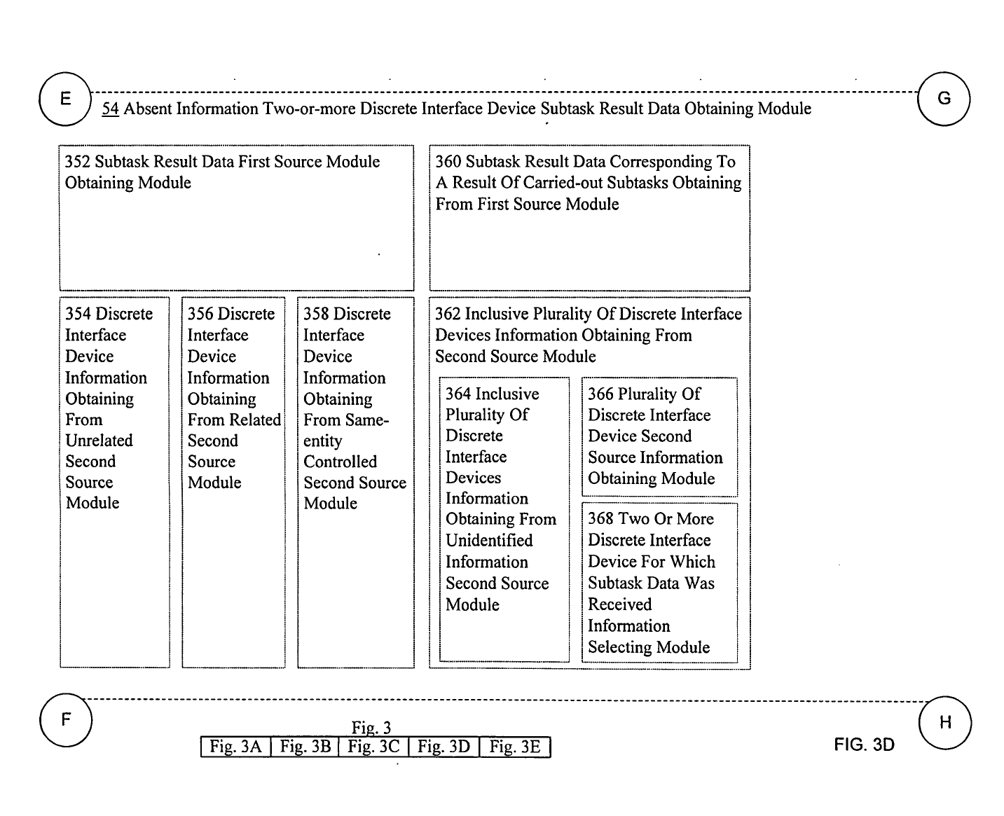

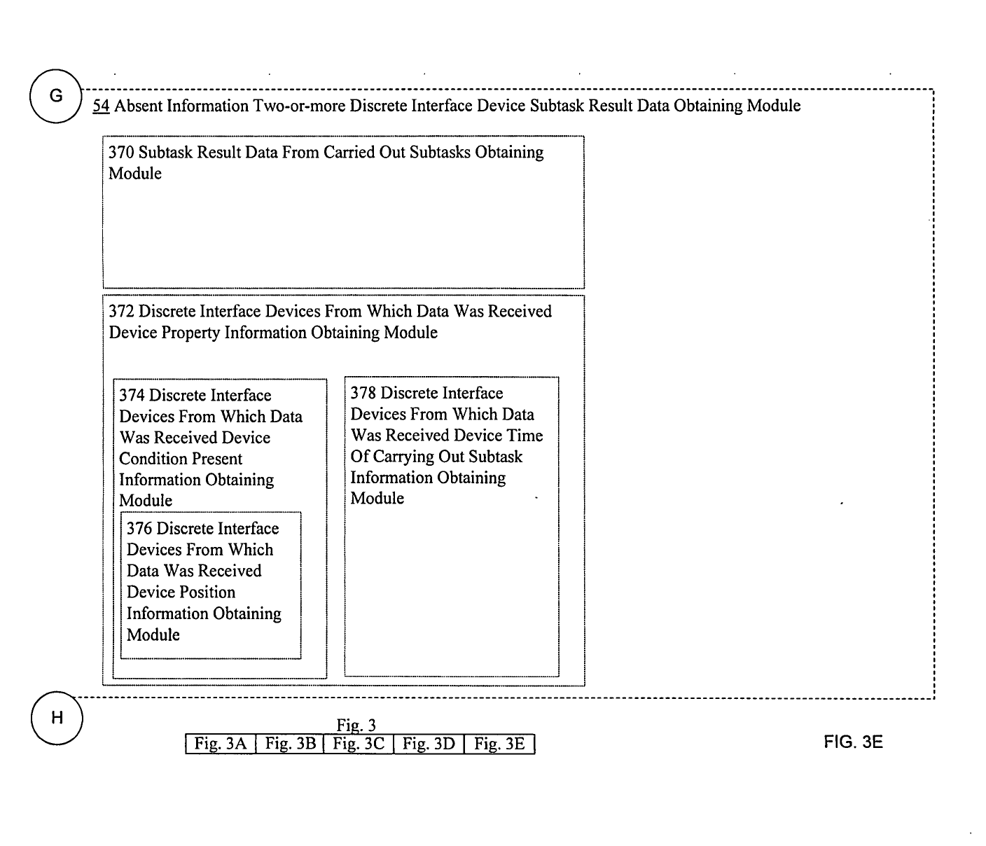

Referring now to FIG. 3, FIG. 3 illustrates an exemplary implementation of the absent information two-or-more discrete interface device subtask result data obtaining module 54 of module 50. As illustrated in FIG. 3, the absent information two-or-more discrete interface device subtask result data obtaining module 54 may include one or more sub-logic modules in various alternative implementations and embodiments. These modules will be discussed in more detail herein with respect to the corresponding methods executed by the various logic and sub-logic modules.

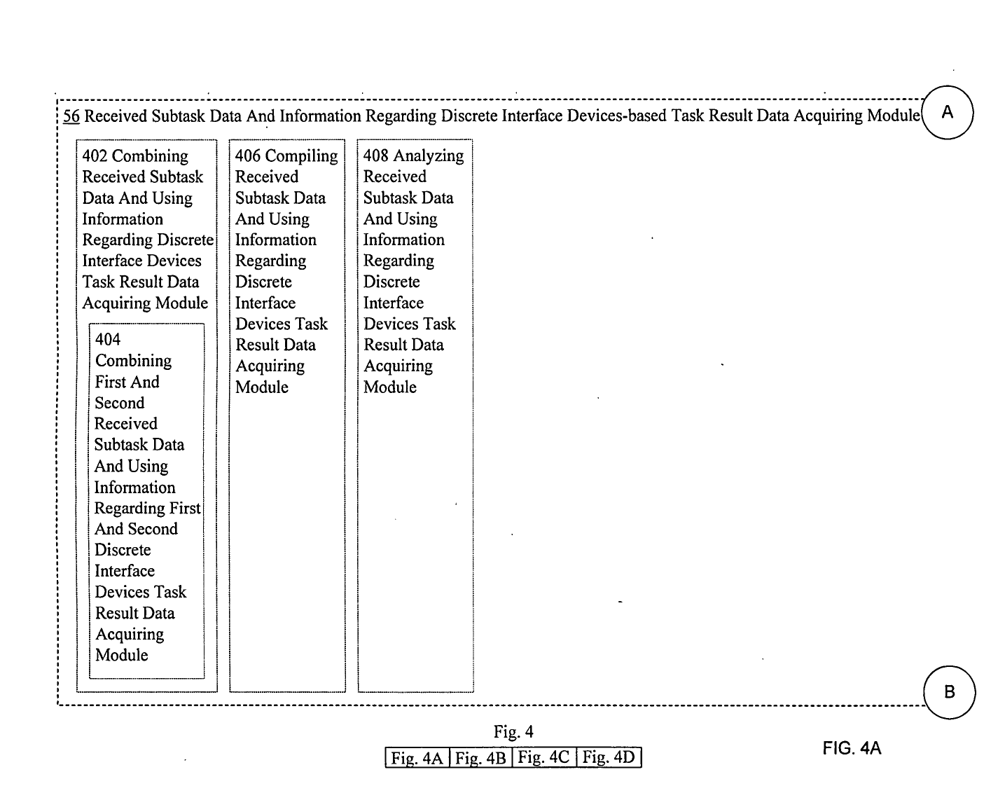

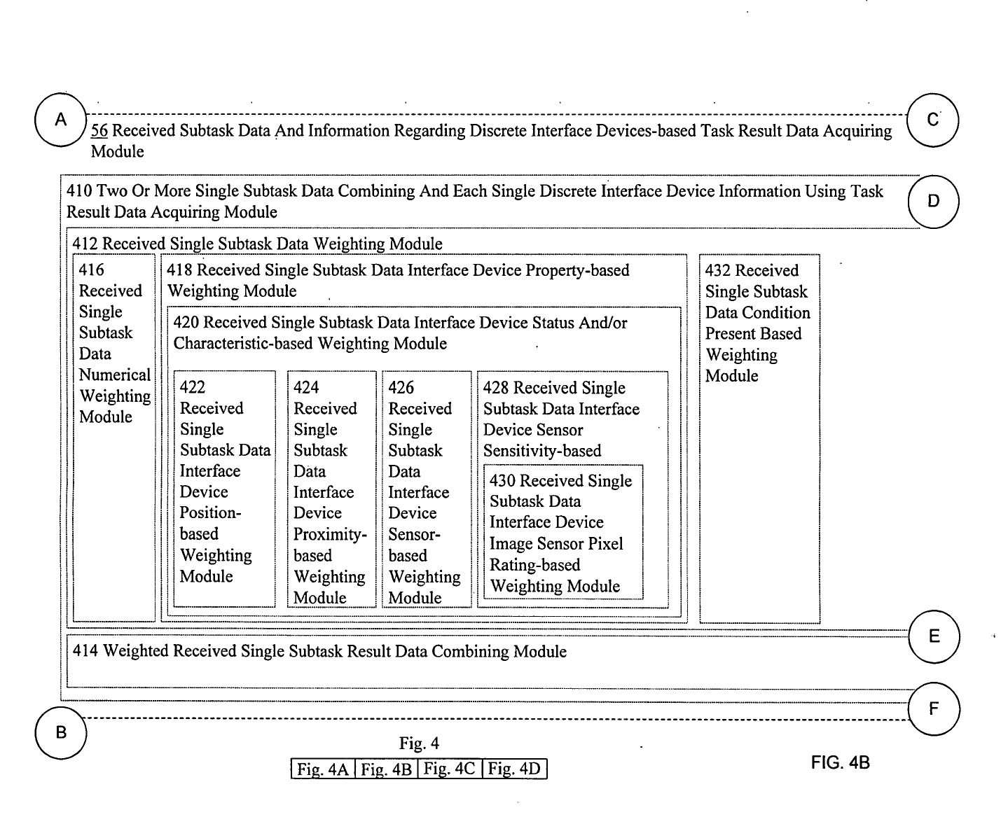

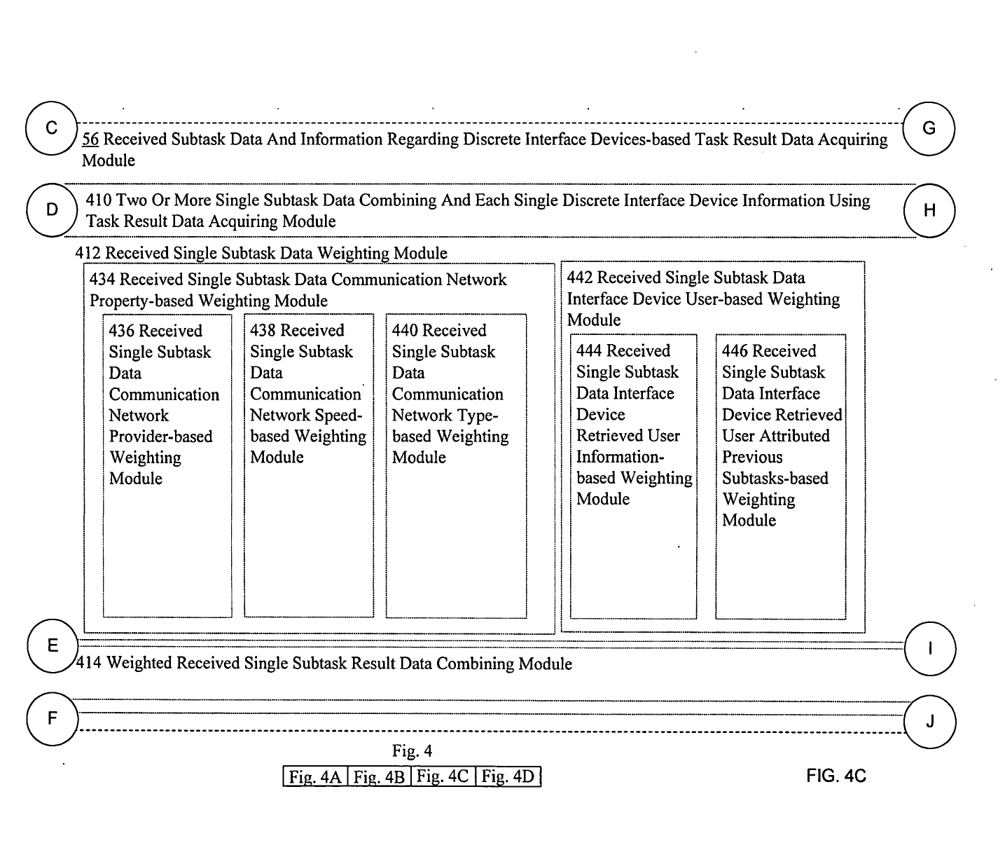

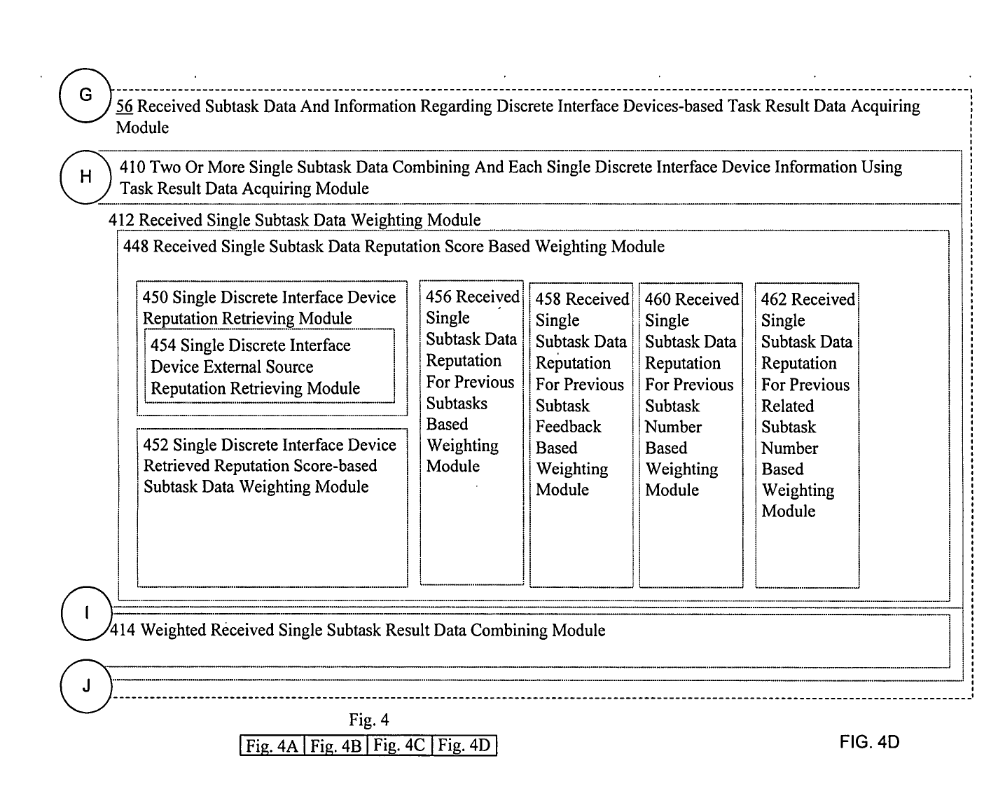

Referring now to FIG. 4, FIG. 4 illustrates an e exemplary implementation of the absent information two-or-more discrete interface device subtask result data obtaining module 54 of module 50. As illustrated in FIG. 4, the received subtask data and information regarding discrete interface devices-based task result data acquiring module 56 may include one or more sub-logic modules in various alternative implementations and embodiments. These modules will be discussed in more detail herein with respect to the corresponding methods executed by the various logic and sub-logic modules.

A more detailed discussion related to computing device 30 of FIG. 1 now will be provided with respect to the processes and operations to be described herein. Referring now to FIG. 5, FIG. 5 illustrates an operational flow 500 representing example operations for, among other methods, transmitting one or more subtasks corresponding to at least a portion of one or more tasks of acquiring data requested by a task requestor to a plurality of discrete interface devices, obtaining subtask result data corresponding to a result of the one or more subtasks carried out by two or more discrete interface devices of the plurality of discrete interface devices in an absence of information regarding the task of acquiring data and/or the task requestor, and acquiring task result data corresponding to a result of the task of acquiring data using the obtained subtask result data and information regarding the two or more discrete interface devices from which the subtask result data is obtained.

In FIG. 5 and in the following figures that include various examples of operational flows, discussions and explanations will be provided with respect to the exemplary environment 100 as described above and as illustrated in FIG. 1, and with respect to other examples (e.g., as provided in FIGS. 2-4) and contexts. It should be understood that the operational flows may be executed in a number of other environments and contexts, and/or in modified versions of the systems shown in FIGS. 2-4. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

Referring again to FIG. 5, FIG. 5 shows operation 500 that may include operation 502 depicting transmitting one or more subtasks corresponding to at least a portion of one or more tasks of acquiring data requested by a task requestor to a plurality of discrete interface devices. For example, FIG. 1 shows one or more subtasks corresponding to at least a portion of one or more requested tasks of acquiring data subtask transmitting module 52 transmitting one or more subtasks (e.g., “activate an image capturing sensor when the image capturing sensor is pointed toward Times Square”) corresponding to at least a portion of one or more tasks of acquiring data (e.g., “take a 360-degree picture of Times Square at midnight”) to a plurality (e.g., two or more) of discrete interface devices (e.g., devices with a camera, (e.g., an Apple iPhone 4, a Samsung Galaxy Tablet, a Pantech Breakout, Samsung Epic Touch, HP Touchpad, Microsoft Zune, Sandisk Sansa Clip+, Kodak Playsport, Asus EeePc, Dell Inspiron 15R laptop, ADT Networked Home Security System, Accuweather Weather Station, Chevy Tahoe with OnStar, TomTom GPS 4100, and others)).

Referring again to FIG. 5, operation 500 may further include operation 504 depicting obtaining subtask result data corresponding to a result of the one or more subtasks carried out by two or more discrete interface devices of the plurality of discrete interface devices in an absence of information regarding the task of acquiring data and/or the task requestor. For example, FIG. 1 shows absent information two-or-more discrete interface device subtask result data receiving module 54 obtaining subtask result data (e.g., image data) corresponding to a result of the one or more subtasks (e.g., “activate an image capturing sensor when the image capturing sensor is pointed toward Times Square”) carried out by two or more discrete interface devices (e.g., the Apple iPhone 4, and the Samsung Galaxy Tablet) of the plurality of discrete interface devices in an absence of information regarding the task of acquiring data and/or the task requestor (e.g., the set of interface devices, when carrying out the subtask, would not know what the task of acquiring data is, only that, at most, they are to take a picture of the Eiffel Tower. In some embodiments, they may be instructed only to activate the image capturing component at a particular time or when the device is oriented in a particular direction. For example, the Samsung Galaxy Tablet may activate its webcamera when its user is sitting in an outdoor coffee shop in view of the Times Square, without knowing for what reason it has activated the webcamera, or, in some embodiments, even that it has activated the webcamera).

Referring again to FIG. 5, operation 500 may also include operation 506 depicting acquiring task result data corresponding to a result of the task of acquiring data using the obtained subtask result data and information regarding the two or more discrete interface devices from which the subtask result data is obtained. For example, FIG. 1 shows received subtask data and information regarding discrete interface devices-based task result data acquiring module 56 acquiring task result data (e.g., the 360-degree picture of Times Square at midnight) corresponding to a result of the task of acquiring data (e.g., “take a 360-degree picture of Times Square at midnight”) using the received subtask data (e.g., the received pictures of Times Square at midnight taken by interface devices”) and information (e.g., identifying information or other information regarding a property of the interface devices) regarding the two or more discrete interface devices (e.g., the Apple iPhone 4 and the Samsung Galaxy Tablet) from which the subtask result data (e.g., the image data) is obtained (e.g., received).

It is noted that “in an absence of information” does not imply a complete absence of information, but rather that the interface devices carrying out the subtasks have a smaller subset of information than a single device carrying out the task of acquiring data would have. In some instances, a sufficiently advanced interface device could infer the task of acquiring data, or guess the task of acquiring data, but the interface device would still be operating in an “absence of information” as defined in the claims. It is not necessary for the interface device to operate in a complete lack of information regarding the task and/or the task requestor to operate in an absence of information. Some exemplary “absence of information” scenarios will be discussed in more detail herein. These examples are not intended to be exhaustive but rather to illustrate examples of scenarios that present an “absence of information.”

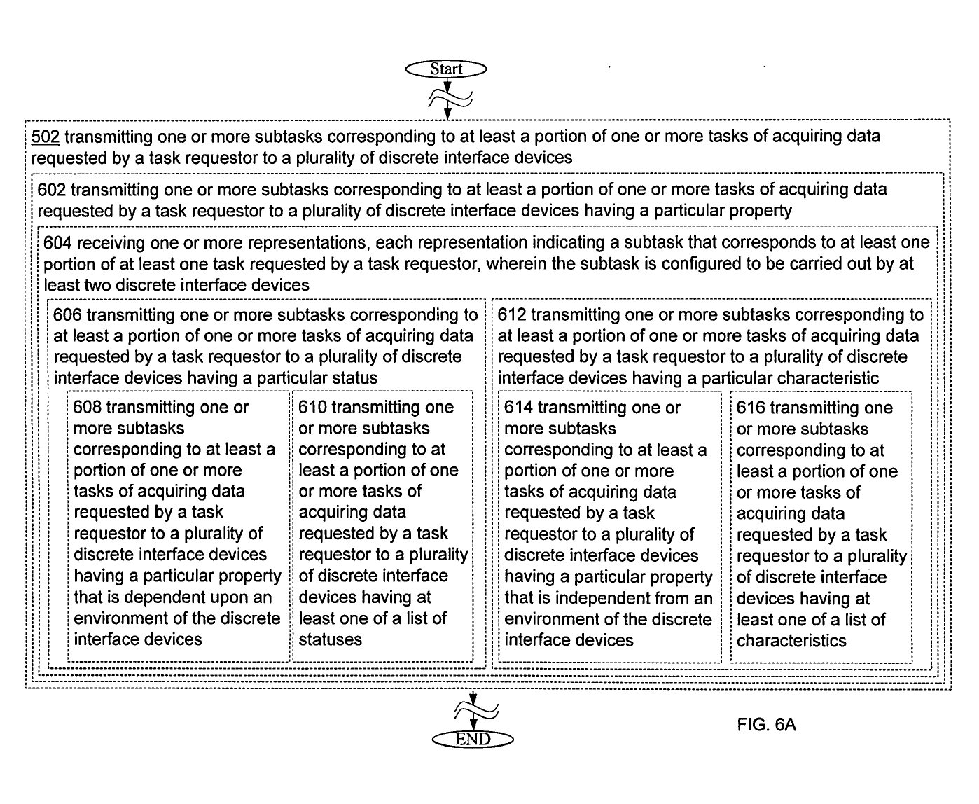

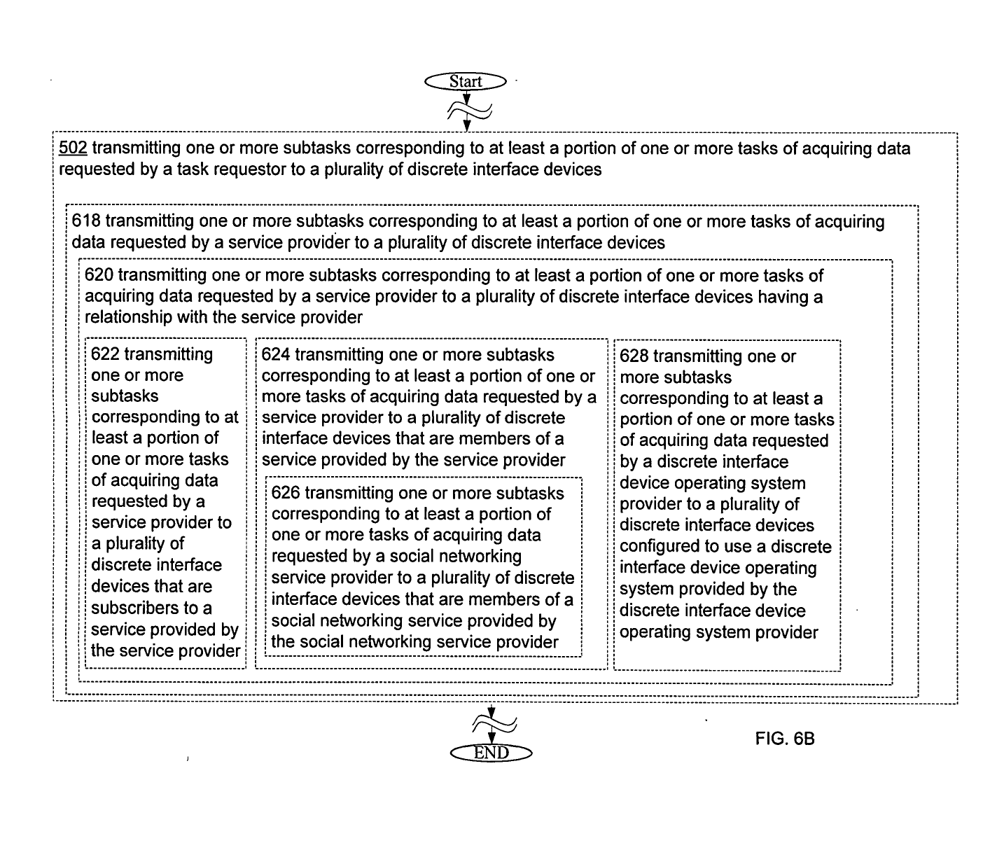

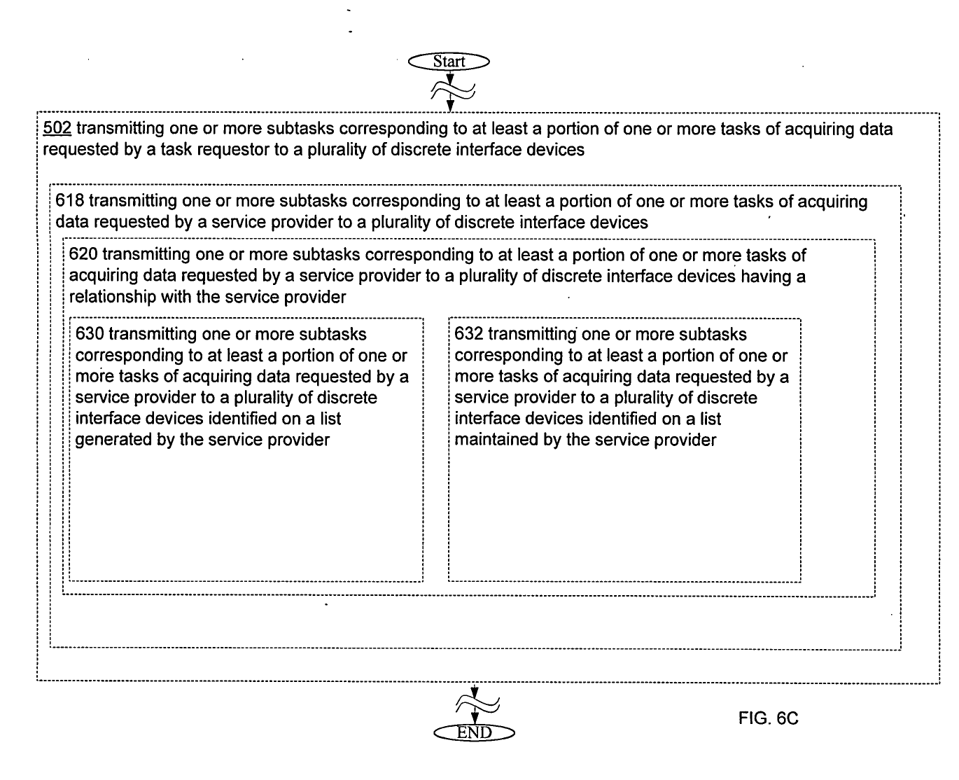

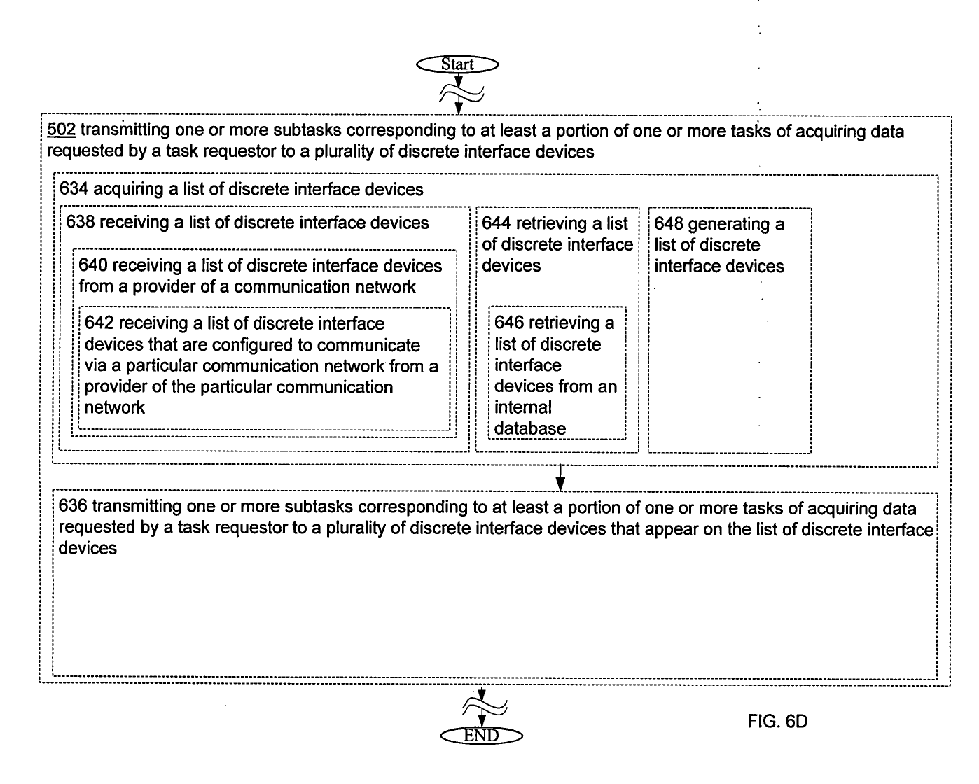

FIGS. 6A-6D depict various implementations of operation 502, according to embodiments. Referring now to FIG. 6, operation 502 may include operation 602 depicting transmitting one or more subtasks corresponding to at least a portion of one or more tasks of acquiring data requested by a task requestor to a plurality of discrete interface devices having a particular property. For example, FIG. 2 shows one or more subtasks corresponding to at least a portion of one or more requested tasks of acquiring data subtask transmitting to devices having a particular property module 202 transmitting one or more subtasks (e.g., “determine how fresh the bagels are at your current location) corresponding to at least a portion of one or more tasks of acquiring data (e.g., “determine which bagel shop in Old Town Alexandria has the freshest bagels”) requested by a task requestor (e.g., Big Apple City Bagel Conglomerate) to a plurality of discrete interface devices (e.g., an Apple iPhone 4, a Samsung Galaxy Tablet, a Pantech Breakout, Samsung Epic Touch, BlackBerry Playbook, Apple iPod, Sandisk Sansa Clip+, Kodak Playsport, Asus EeePc, Dell Inspiron 15R laptop) having a particular property (e.g., “located at a bagel shop”).

Referring again to FIG. 6A, operation 602 may include operation 604 depicting transmitting one or more subtasks corresponding to at least a portion of one or more tasks of acquiring data requested by a task requestor to a plurality of discrete interface devices having a particular status and/or characteristic. For example, FIG. 2 shows one or more subtasks corresponding to at least a portion of one or more requested tasks of acquiring data subtask transmitting to devices having a particular status and/or characteristic module 204 transmitting one or more subtasks (e.g., “take a picture of Times Square”) corresponding to at least a portion of one or more tasks of acquiring data (e.g., “take a 360 degree near-real time picture of Times Square”) requested by a task requestor to a plurality of discrete interface devices (e.g., a Pantech Pocket, a Nokia Lumina, and a Kyocera DuraCore) having a particular status and/or characteristic (e.g., the plurality of discrete interface devices each have a cellular network radio).

Referring again to FIG. 6A, operation 604 may include operation 606 depicting transmitting one or more subtasks corresponding to at least a portion of one or more tasks of acquiring data requested by a task requestor to a plurality of discrete interface devices having a particular status. For example, FIG. 2 shows one or more subtasks corresponding to at least a portion of one or more requested tasks of acquiring data subtask transmitting to devices having a particular status module 206 transmitting one or more subtasks (e.g., “determine your speed on I-495 at your current location”) corresponding to at least a portion of one or more tasks of acquiring data (e.g., “determine how bad traffic is on the south branch of I-495”) requested by a task requestor (e.g., Virginia Dept. of Transportation (VDOT)) to a plurality of discrete interface devices (e.g., an Apple iPhone 4S and a Garmin Nuvi 4300) having a particular status (e.g., positioned on a particular portion of I-495).

Referring again to FIG. 6A, operation 606 may include operation 608 depicting transmitting one or more subtasks corresponding to at least a portion of one or more tasks of acquiring data requested by a task requestor to a plurality of discrete interface devices having a particular property that is dependent upon an environment of the discrete interface devices. For example, FIG. 2 shows one or more subtasks corresponding to at least a portion of one or more requested tasks of acquiring data subtask transmitting to devices having a particular environment dependent property module 208 transmitting one or more subtasks (e.g., “determine the 4G network upload speed at your current location”) corresponding to at least a portion of one or more tasks of acquiring data (e.g., “determine which parts of Clarendon, Va. have the fastest 4G upload speeds”) requested by a task requestor to a plurality of discrete interface devices (e.g., an Apple iPhone 4, a Motorola Brute, a Motorola Droid Razr, a Pantech Breakout, Samsung Epic Touch, HP Touchpad, Microsoft Zune, Kodak Playsport, an Asus EeePc, and others) having a particular property (e.g., “is connected to a 4G network”) that is dependent upon an environment of the discrete interface devices.

Referring again to FIG. 6A, operation 606 may include operation 610 depicting transmitting one or more subtasks corresponding to at least a portion of one or more tasks of acquiring data requested by a task requestor to a plurality of discrete interface devices having at least one of a particular position, proximity to a predetermined point, acceleration, velocity, and an ambient condition. For example, FIG. 2 shows one or more subtasks corresponding to at least a portion of one or more requested tasks of acquiring data subtask transmitting to devices having a list of statuses module 210 transmitting one or more subtasks (e.g., “determine the 4G network upload speed at your current location”) corresponding to at least a portion of one or more tasks of acquiring data (e.g., “determine which parts of Clarendon, Va. have the fastest 4G upload speeds”) requested by a task requestor to a plurality of discrete interface devices (e.g., an Apple iPhone 4, a Motorola Brute, a Motorola Droid Razr, a Pantech Breakout, Samsung Epic Touch, HP Touchpad, Microsoft Zune, Kodak Playsport, an Asus EeePc, and others) having at least one of a particular position, proximity to a predetermined point, acceleration, velocity, and an ambient condition (e.g. a particular position, e.g., located in Clarendon, Va.).

Referring again to FIG. 6A, operation 604 may include operation 612 depicting transmitting one or more subtasks corresponding to at least a portion of one or more tasks of acquiring data requested by a task requestor to a plurality of discrete interface devices having a particular characteristic. For example, FIG. 2 shows one or more subtasks corresponding to at least a portion of one or more requested tasks of acquiring data subtask transmitting to devices having a particular characteristic module 212 transmitting one or more subtasks (e.g., “for interface devices in proximity to Times Square, activate the image capturing sensor”) corresponding to at least a portion of one or more tasks of acquiring data (e.g., “acquire a 360 degree near-real time picture of Times Square”) requested by a task requestor to a plurality of discrete interface devices (e.g., an Apple iPhone 4, a Motorola Brute, a Motorola Droid Razr, a Pantech Breakout, Samsung Epic Touch, HP Touchpad, Kodak Playsport, an Asus EeePc, and others) having a particular characteristic (e.g., devices that have an image capturing sensor.

Referring again to FIG. 6A, operation 612 may include operation 614 depicting transmitting one or more subtasks corresponding to at least a portion of one or more tasks of acquiring data requested by a task requestor to a plurality of discrete interface devices having a particular property that is independent from an environment of the discrete interface devices. For example, FIG. 2 shows one or more subtasks corresponding to at least a portion of one or more requested tasks of acquiring data subtask transmitting to devices having a particular environment independent property module 214 transmitting one or more subtasks (e.g., “determine a loudness of the band U2 at your seat in Merriweather Post Pavilion”) corresponding to at least a portion of one or more tasks of acquiring data (e.g., find the quietest seats at Merriweather Post Pavilion) requested by a task requestor (e.g., an interface device whose user has an infant child) to a plurality of discrete interface devices (e.g., a Sony Personal Recorder, a Samsung Galaxy S II) having a particular property that is independent from an environment of the discrete interface devices (e.g., devices that have a microphone having a sensitivity greater than a particular level).

Referring again to FIG. 6A, operation 612 may include operation 616 depicting transmitting one or more subtasks corresponding to at least a portion of one or more tasks of acquiring data requested by a task requestor to a plurality of discrete interface devices having one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor. For example, FIG. 2 shows one or more subtasks corresponding to at least a portion of one or more requested tasks of acquiring data subtask transmitting to devices having a list of characteristics module 216 transmitting one or more subtasks (e.g., “determine a loudness of the band U2 at your seat in Merriweather Post Pavilion”) corresponding to at least a portion of one or more tasks of acquiring data (e.g., find the quietest seats at Merriweather Post Pavilion) requested by a task requestor (e.g., an interface device whose user has an infant child) to a plurality of discrete interface devices (e.g., a Sony Personal Recorder, a Samsung Galaxy S II) having one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor (e.g., devices that have a microphone).

Referring now to FIG. 6B, operation 502 may include operation 618 depicting transmitting one or more subtasks corresponding to at least a portion of one or more tasks of acquiring data requested by a service provider to a plurality of discrete interface devices. For example, FIG. 2 shows one or more subtasks requested by a service provider transmitting to discrete interface devices module 218 transmitting one or more subtasks (e.g., “determine how many pictures are stored on a discrete interface device”) corresponding to at least a portion of one or more tasks of acquiring data (e.g., “determine how many pictures are stored in the memory of an average smartphone located in Arlington, Va.”) requested by a service provider (e.g., Shutterfly) to a plurality of discrete interface devices (e.g., an Apple iPhone 4 and a Nokia E7).

Referring again to FIG. 6B, operation 618 may include operation 620 depicting transmitting one or more subtasks corresponding to at least a portion of one or more tasks of acquiring data requested by a service provider to a plurality of discrete interface devices having a relationship with the service provider. For example, FIG. 2 shows one or more subtasks requested by a service provider transmitting to service provider related discrete interface devices module 220 transmitting one or more subtasks (e.g., “activate the air quality sensor”) corresponding to at least a portion of one or more tasks of acquiring data (e.g., “determine the exact pollen count right now at Arlington National Cemetery”) requested by a service provider (e.g., Facebook) to a plurality of discrete interface devices (e.g., a Samsung Focus S and a BlackBerry Bold) having a relationship with the service provider (e.g., the devices have logged in to Facebook previously).

Referring again to FIG. 6B, operation 620 may include operation 622 depicting transmitting one or more subtasks corresponding to at least a portion of one or more tasks of acquiring data requested by a service provider to a plurality of discrete interface devices that are subscribers to a service provided by the service provider. For example, FIG. 2 shows one or more subtasks requested by a service provider transmitting to service provider subscribed discrete interface devices module 222 transmitting one or more subtasks (e.g., “for interface devices in proximity to the Eiffel Tower, activate the image capturing sensor”) corresponding to at least a portion of one or more tasks of acquiring data (e.g., “acquire a 360 degree picture of the Eiffel Tower”) requested by a service provider (e.g., MySpace) to a plurality of discrete interface devices that are subscribers (e.g., the devices or users of the devices have logged into the service and subscribed to using the service) to a service (e.g., a social networking site) provided by the service provider (e.g., MySpace).

Referring again to FIG. 6B, operation 620 may include operation 624 depicting transmitting one or more subtasks corresponding to at least a portion of one or more tasks of acquiring data requested by a service provider to a plurality of discrete interface devices that are members of a service provided by the service provider. For example, FIG. 2 shows one or more subtasks requested by a service provider transmitting to service provider member discrete interface devices module 224 transmitting one or more subtasks (e.g., “determine how fast you are moving across the I-95 bridge at your location”) corresponding to at least a portion of one or more tasks of acquiring data (e.g., “determine the traffic patterns across I-95 prior to a Washington Nationals baseball game”) requested by a service provider (e.g., Facebook) to a plurality of discrete interface devices (e.g., HTC Rezound, Motorola Droid Razr) that are members (e.g., the interface devices are associated with a user that is a member of the service) of a service provided by the service provider (e.g., social networking).

Referring again to FIG. 6B, operation 624 may include operation 626 depicting transmitting one or more subtasks corresponding to at least a portion of one or more tasks of acquiring data requested by a social networking service provider to a plurality of discrete interface devices that are members of a social networking service provided by the social networking service provider. For example, FIG. 2 shows one or more subtasks requested by a social networking service provider transmitting to social networking service provider member discrete interface devices module 226 transmitting one or more subtasks (e.g., “activate the air quality sensor”) corresponding to at least a portion of one or more tasks of acquiring data (e.g., (“determine the daily pollen count for people who work at the U.S. Patent and Trademark Office”) requested by a social networking service provider (e.g., Linkedln) to a plurality of discrete interface devices that are members of a social networking service provided by the social networking service provider (e.g., the LinkedIn jobs search and question bulletin board).

Referring again to FIG. 6B, operation 620 may include operation 628 transmitting one or more subtasks corresponding to at least a portion of one or more tasks of acquiring data requested by a discrete interface device operating system provider to a plurality of discrete interface devices configured to use a discrete interface device operating system provided by the discrete interface device operating system provider. For example, FIG. 2 shows one or more subtasks requested by a discrete interface device operating system provider transmitting to discrete interface devices using operating system module 228 transmitting one or more subtasks (e.g., “determine the wireless network strength at McDonald's in Bellevue, Wash.) corresponding to at least a portion of one or more tasks of acquiring data (e.g., “determine which McDonald's of the ones in Bellevue, Wash., have the fastest internet connection.”) requested by a discrete interface device operating system (e.g. Android) provider (e.g., Google) to a plurality of discrete interface devices (e.g., Nook Color, Samsung Galaxy S II) configured to use a discrete interface device operating system (Android) provided by the discrete interface device operating system provider (e.g., Google).

Referring now to FIG. 6C, operation 620 may include operation 630 depicting transmitting one or more subtasks corresponding to at least a portion of one or more tasks of acquiring data requested by a service provider to a plurality of discrete interface devices identified on a list generated by the service provider. For example, FIG. 2 shows one or more subtasks requested by a service provider transmitting to a service provider list of discrete interface devices module 230 transmitting one or more subtasks (e.g., “take a picture of Times Square”) corresponding to at least a portion of one or more tasks of acquiring data (e.g., the task is “take a 360-degree picture of Times Square when the new Reebok ad pops up at 8:01:32 a.m.,”) requested by a service provider (e.g., Twitter) to a plurality of discrete interface devices (e.g., an Apple iPhone, a Dell XPS 15 laptop) identified on a list generated by the service provider (e.g., a list maintained by Twitter of devices to which they send updates, e.g., are “following.”).

Referring again to FIG. 6C, operation 620 may include operation 632 depicting transmitting one or more subtasks corresponding to at least a portion of one or more tasks of acquiring data requested by a service provider to a plurality of discrete interface devices identified on a list maintained by the service provider. For example, FIG. 2 shows one or more subtasks requested by a service provider transmitting to a service provider maintained list of discrete interface devices module 232 transmitting one or more subtasks (e.g., “determine the pollen count on Cherry Blossom Drive in Washington, D.C.”) corresponding to at least a portion of one or more tasks of acquiring data requested by a service provider (e.g., Microsoft, which provides Windows), to a plurality of discrete interface devices (e.g., devices running MS Windows) identified on a list maintained by the service provider (e.g., Microsoft).

Referring now to FIG. 6D, operation 502 may include operation 634 depicting acquiring a list of discrete interface devices. For example, FIG. 2 shows discrete interface device list acquiring module 234 acquiring (e.g., receiving from a source, or generating, or creating, or retrieving from a database or from a memory or storage) a list of discrete interface devices (e.g., a list of devices, either subscribers to a service, or visible devices on a network, or any list, either partially retrieved, fully retrieved, or retrieved as needed, or created or generated, from any location).

Referring again to FIG. 6D, operation 502 may include operation 636 depicting transmitting one or more subtasks corresponding to at least a portion of one or more tasks of acquiring data requested by a task requestor to a plurality of discrete interface devices that appear on the list of discrete interface devices. For example, FIG. 2 shows one or more subtask transmitting to discrete interface devices on acquired list module 236 transmitting one or more subtasks (e.g., “take a picture of the Space Needle”) corresponding to at least a portion of one or more tasks of acquiring data requested by a task requestor to a plurality of discrete interface devices (e.g., a Nokia Lumia and a Samsung Epic 4G) that appear on the list of discrete interface devices).

Referring again to FIG. 6D. operation 634 may include operation 638 depicting receiving a list of discrete interface devices. For example, FIG. 2 shows discrete interface device list receiving module 238 receiving from a source, e.g., from a database or from a memory or storage) a list of discrete interface devices (e.g., a list of devices, either subscribers to a service, or visible devices on a network, or any list, either partially retrieved, fully retrieved, or retrieved as needed, or created or generated, from any location).

Referring again to FIG. 6D, operation 638 may include operation 640 depicting receiving a list of discrete interface devices from a provider of a communication network. For example, FIG. 2 shows discrete interface device list from communication network provider receiving module 240 receiving from a source, e.g., from a database or from a memory or storage) a list of discrete interface devices (e.g., a list of devices, either subscribers to a service, or visible devices on a network, or any list, either partially retrieved, fully retrieved, or retrieved as needed, or created or generated, from any location) from a provider of a communication network (e.g., Sprint, which provides the communication network WiMax 4G).

Referring again to FIG. 6D, operation 640 may include operation 642 depicting receiving a list of discrete interface devices that are configured to communicate via a particular communication network from a provider of the particular communication network. For example, FIG. 2 shows discrete interface device using communication network list from communication network provider receiving module 242 receiving a list of discrete interface devices (e.g., Samsung Galaxy S II, Pantech Breakout) that are configured to communicate via a particular communication network (e.g., Sprint's WiMax 4G network) from a provider of the particular communication network (e.g., Sprint).

Referring again to FIG. 6D, operation 634 may include operation 644 depicting retrieving a list of discrete interface devices. For example, FIG. 2 shows discrete interface device retrieving module 244 retrieving (e.g., retrieving from a database or from a memory or storage) a list of discrete interface devices (e.g., a list of devices, either subscribers to a service, or visible devices on a network, or any list, either partially retrieved, fully retrieved, or retrieved as needed, or created or generated, from any location).

Referring again to FIG. 6D, operation 644 may include operation 646 depicting retrieving a list of discrete interface devices from an internal database. For example, FIG. 2 shows discrete interface device internal database retrieving module 246 retrieving from an internal database (e.g., a data structure that is accessible without transmitting the data across a shared communication network) a list of discrete interface devices (e.g., a list of devices, either subscribers to a service, or visible devices on a network, or any list, either partially retrieved, fully retrieved, or retrieved as needed, or created or generated, from any location).

Referring again to FIG. 6D, operation 634 may include operation 648 depicting generating a list of discrete interface devices. For example, FIG. 2 shows discrete interface device list generating module 248 creating a list of discrete interface devices (e.g., a list of devices, either subscribers to a service, or visible devices on a network, or any list, either partially retrieved, fully retrieved, or retrieved as needed, or created or generated, from any location).

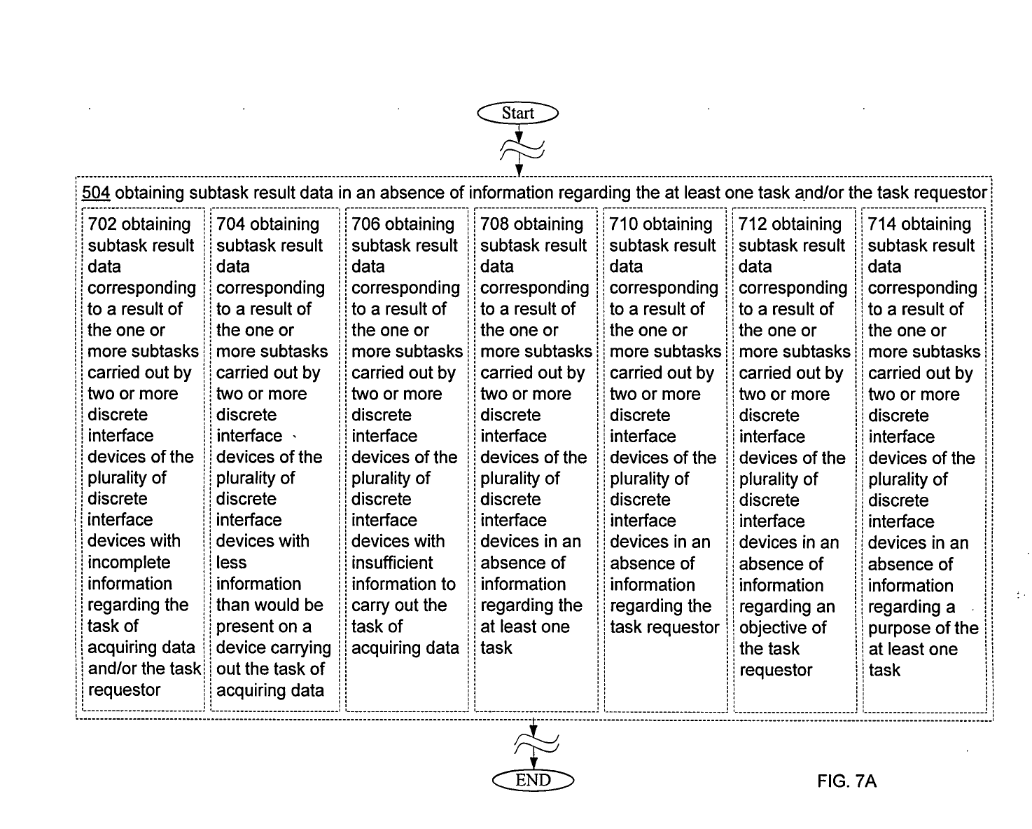

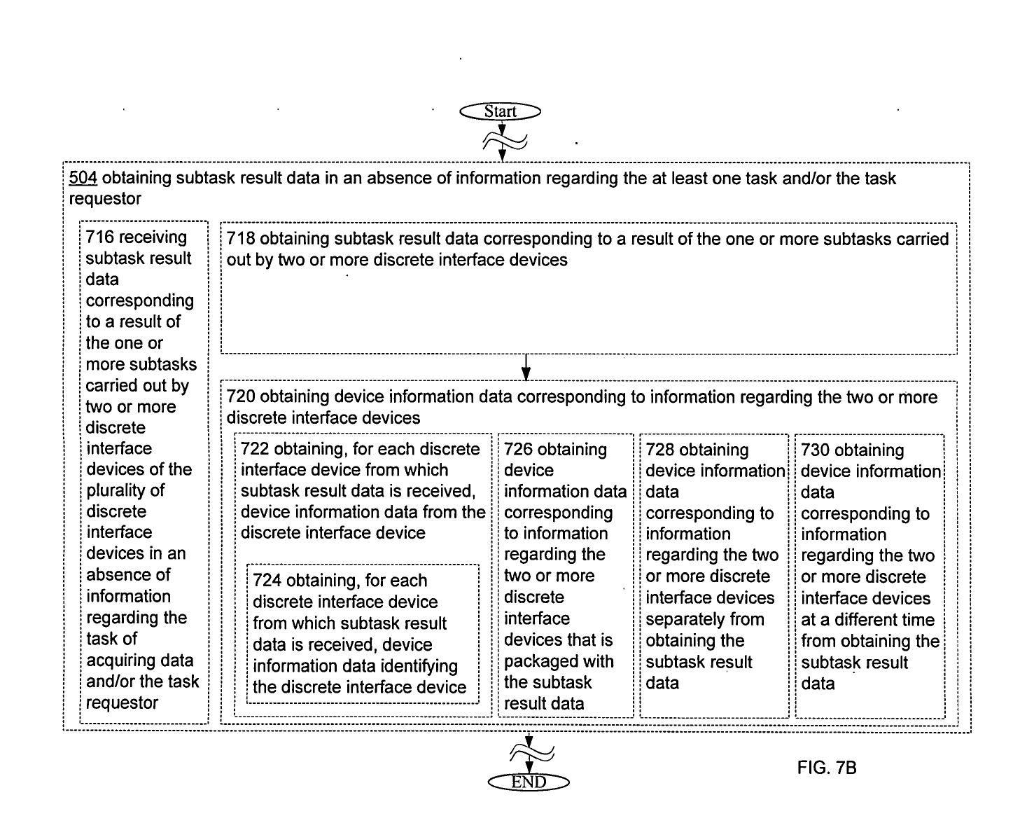

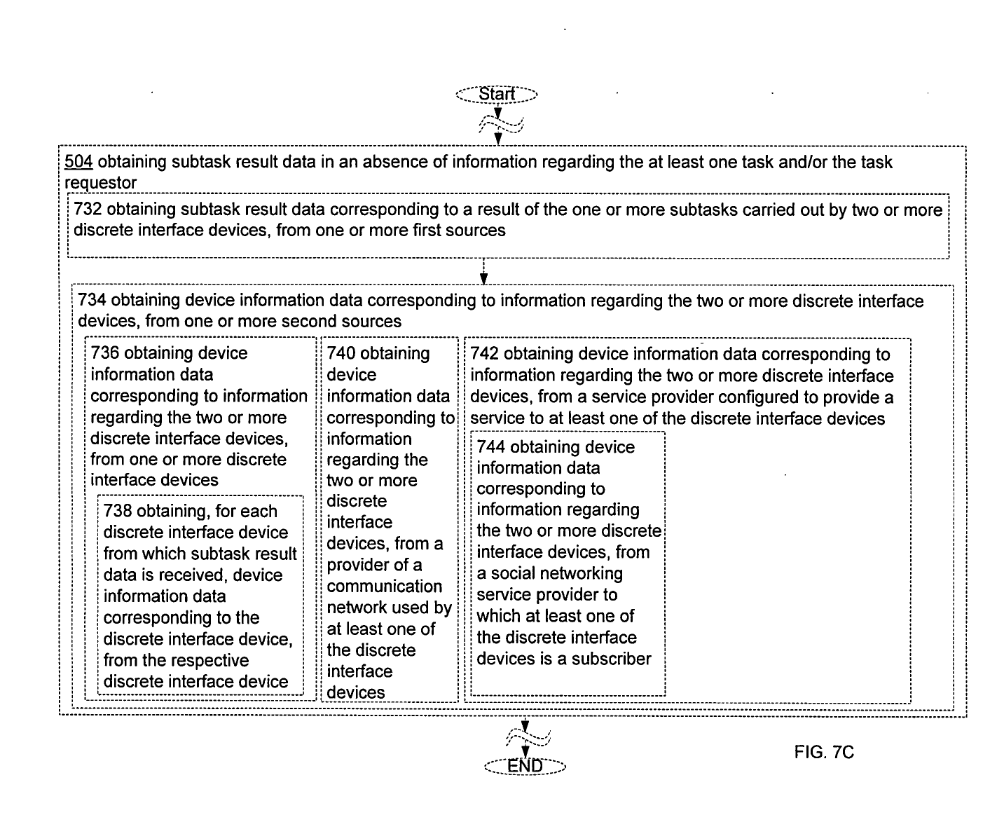

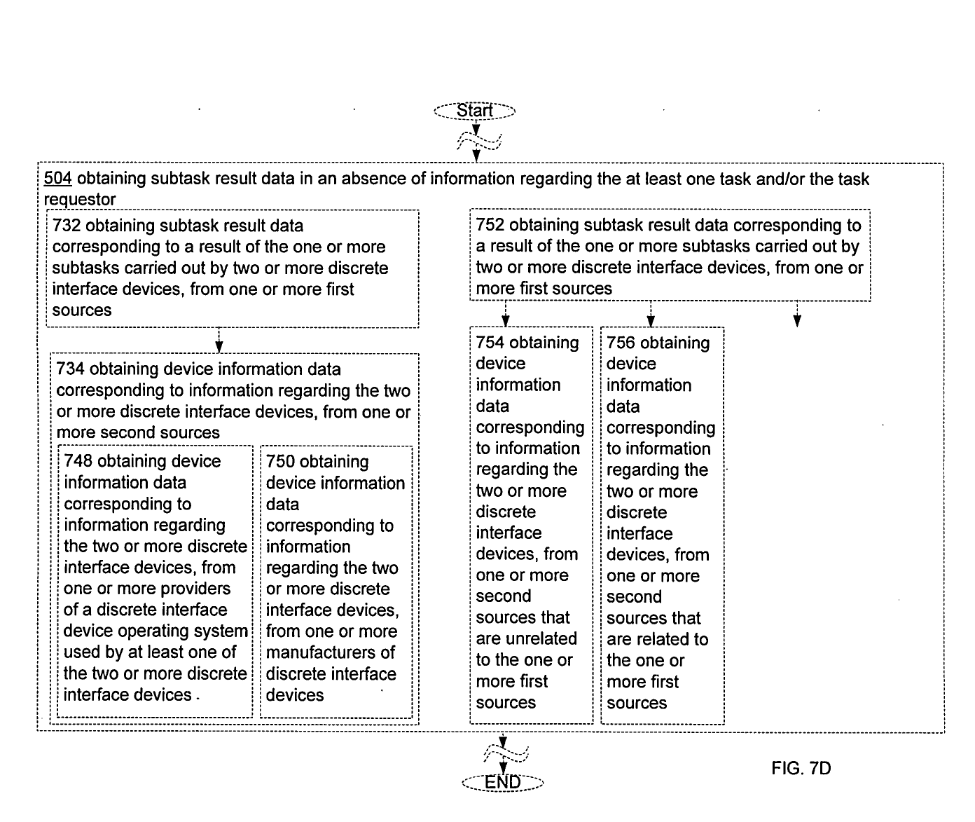

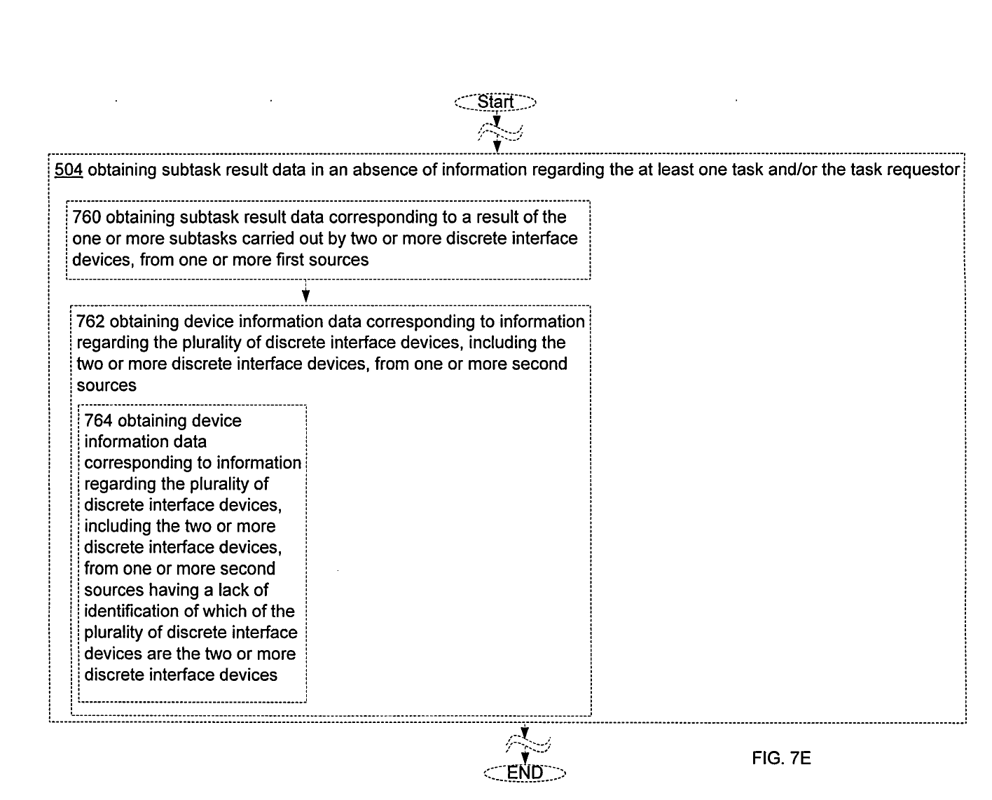

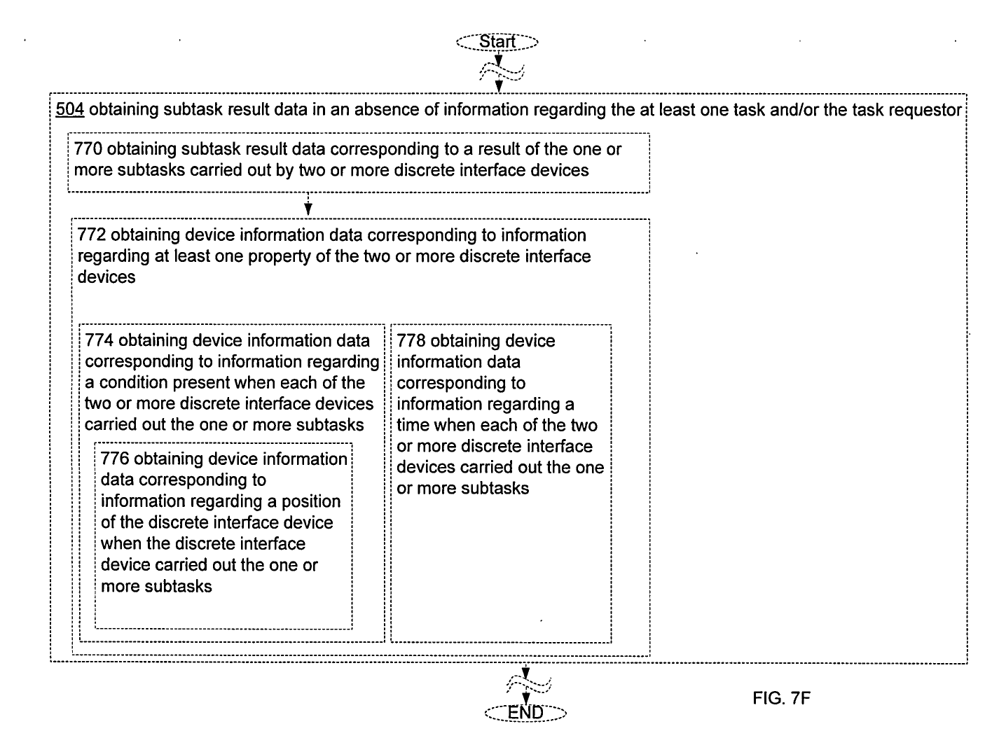

FIGS. 7A-7D depict various implementations of operation 504, according to embodiments. Referring now to FIG. 7A, operation 504 may include operation 702 depicting obtaining subtask result data corresponding to a result of the one or more subtasks carried out by two or more discrete interface devices of the plurality of discrete interface devices with incomplete information regarding the task of acquiring data and/or the task requestor. For example, FIG. 3 shows incomplete information subtask result data obtaining module 302 obtaining subtask result data (e.g., speed data as a result of the subtask of “determine how fast you are moving across the I-90 bridge at your location”) corresponding to a result of the one or more subtasks carried out by two or more discrete interface devices (e.g., an iPhone in a glove box, and a Nokia E5 in a passenger's pocket), of the plurality of discrete interface devices with incomplete information regarding the task requestor (e.g., the iPhone and Nokia E5 do not know the identity of the task requestor or the type of entity, e.g., personal, corporate, automated) and/or the task of acquiring data (e.g., the task of “determine the fastest way into Seattle at 4:25 PM from Bellevue, Wash.,” the iPhone and the Nokia E5 do not know the task, and whether it is “determine the fastest way,” or “monitor traffic conditions,” or any details about how the information the devices are gathering will be used, and to answer which queries).

Referring again to FIG. 7A, operation 504 may include operation 704 depicting obtaining subtask result data corresponding to a result of the one or more subtasks carried out by two or more discrete interface devices of the plurality of discrete interface devices with less information than would be present on a device carrying out the task of acquiring data. For example, FIG. 3 shows less information subtask result data obtaining module 304 obtaining subtask result data (e.g., image data) corresponding to a result of the one or more subtasks, (e.g., “determine the view from your location at Safeco field”) carried out by two or more discrete interface devices (e.g., a Samsung Galaxy II and a Motorola Droid 3) of the plurality of discrete interface devices with less information than would be present on a device carrying out the task of acquiring data (e.g., the Samsung Galaxy II and the Droid 3 only activate their image collecting component and collect data. The task is “determine how full the rows are in the upper deck at Safeco Field.” The devices have no idea whether they are capturing images of the fans in the stands, of the view, of the weather, of the sunlight, or of the best time to avoid shadows, or to determine whether the seats are covered. In contrast, a device carrying out the task by itself (which would have to go to each row of the park) would know to determine how full the rows are because of knowledge of the task).

Referring again to FIG. 7A, operation 504 may include operation 706 depicting obtaining subtask result data corresponding to a result of the one or more subtasks carried out by two or more discrete interface devices of the plurality of discrete interface devices with insufficient information to carry out the task of acquiring data. For example, FIG. 3 shows insufficient information subtask result data obtaining module 306

Referring again to FIG. 7A, operation 504 may include operation 708 depicting obtaining subtask result data corresponding to a result of the one or more subtasks carried out by two or more discrete interface devices of the plurality of discrete interface devices in an absence of information regarding the at least one task. For example, FIG. 3 shows absent task information subtask result data obtaining module 308 obtaining subtask result data (e.g., wireless network information) corresponding to a result of the one or more subtasks (e.g., “determine the wireless network strength at McDonald's in Bellevue, Wash.) carried out by two or more discrete interface devices (e.g., a Droid Revolution and a Nokia E650 smartphone) of the plurality of discrete interface devices with insufficient information to carry out the task of acquiring data (e.g., the task of acquiring data is “determine which McDonald's of the ones in Bellevue, Wash., have the fastest interne connection.” The interface devices have insufficient information to complete this task because they are merely measuring wireless strength at McDonald's. They do not know whether to measure strength at various McDonald's, various types of signal strength at that McDonald's (e.g., cellular network strength), whether to measure the signal strength at a particular time, or over a particular period of time. The Droid Revolution and the Nokia E650 have insufficient information to carry out the entire task, but are capable of carrying out the subtask that was transmitted to them).

Referring again to FIG. 7A, operation 504 may include operation 710 depicting obtaining subtask result data corresponding to a result of the one or more subtasks carried out by two or more discrete interface devices of the plurality of discrete interface devices in an absence of information regarding the task requestor. For example, FIG. 3 shows absent task requestor information subtask result data obtaining module 310 obtaining subtask result data (e.g., image data) corresponding to a result of the one or more subtasks (e.g., “take a picture of Times Square”) carried out by two or more discrete interface devices of the plurality of discrete interface devices (e.g., Samsung Epic Touch smartphone, HTC Evo smartphone) in an absence of information regarding the at least one task requestor (e.g., the task is “take a 360-degree picture of Times Square when the new Reebok ad pops up at 8:01:32 a.m.,” and the task requestor is Reebok, and the discrete interface devices do not have the information regarding the task requestor, e.g., identity, or which type, e.g., corporate or personal, human or machine query).

Referring again to FIG. 7A, operation 504 may include operation 712 depicting obtaining subtask result data corresponding to a result of the one or more subtasks carried out by two or more discrete interface devices of the plurality of discrete interface devices in an absence of information regarding an objective of the task requestor. For example, FIG. 3 shows absent task requestor objective information subtask result data obtaining module 312 obtaining subtask result data (e.g., loudness data) corresponding to a result of the one or more subtask (e.g., “determine the loudness level at your seat during the Pearl Jam concert”) carried out by two or more discrete interface devices (e.g., the iPhone 4 and the Samsung Focus S) of the plurality of discrete interface devices in an absence of information regarding an objective of the task requestor (e.g. the task is “determine how loud the crowd is for the Pearl Jam concert at Key Arena on September 19”), and the iPhone 4 and the Samsung Focus S do not know who made the request, the identity of the task requestor, or even whether the task requestor is a corporate entity interested in tracking Pearl Jam's popularity, an old lady trying to decide if the concert will be too loud for her, a young couple determining whether to bring their infant to the show, or a Pearl Jam fan site webmaster tracking information about Pearl Jam at shows that he cannot attend personally.

Referring again to FIG. 7A, operation 504 may include operation 714 depicting obtaining subtask result data corresponding to a result of the one or more subtasks carried out by two or more discrete interface devices of the plurality of discrete interface devices in an absence of information regarding a purpose of the at least one task. For example, FIG. 3 shows absent task purpose information subtask result data obtaining module 314

Referring now to FIG. 7B, operation 504 may include operation 716 depicting receiving subtask result data corresponding to a result of the one or more subtasks carried out by two or more discrete interface devices of the plurality of discrete interface devices in an absence of information regarding the task of acquiring data and/or the task requestor. For example, FIG. 3 shows absent information subtask result data receiving module 316 receiving subtask result data (e.g., rainfall data) corresponding to a result of the one or more subtasks (e.g., “how much rain fell in your location in the last six hours”) carried out by two or more discrete interface devices (e.g., a smartphone with a precipitation detector, and a smartphone where the user is queried for an answer) of the plurality of discrete interface devices in an absence of information regarding a purpose of the at least one task (e.g., the smartphones carrying out the task do not know if the purpose is to “track rainfall” or “determine where to visit in order to get sunshine,” or “predict the weather patterns moving east”).

Referring again to FIG. 7B, operation 504 may include operation 718 depicting obtaining subtask result data corresponding to a result of the one or more subtasks carried out by two or more discrete interface devices. For example, FIG. 3 shows subtask result data corresponding to a result of one or more interface device carried-out subtasks obtaining module 318 obtaining subtask result data corresponding to a result of the one or more subtasks (e.g., image data from a subtask of “take a picture of Times Square at midnight on New Years'Eve”).carried out by two or more discrete interface devices (e.g., an Apple iPhone 4, a Motorola Brute, a Motorola Droid Razr, a Pantech Breakout, Samsung Epic Touch, HP Touchpad, Microsoft Zune, Kodak Playsport, an Asus EeePc, and others).

Referring again to FIG. 7B, operation 504 may further include operation 720 depicting obtaining device information data corresponding to information regarding the two or more discrete interface devices. For example, FIG. 3 shows discrete interface devices from which data was received device information obtaining module 320 obtaining device information data (e.g., identifying information regarding the device or the user of the device, or of a status or characteristic of the device) corresponding to information regarding the two or more discrete interface devices (e.g., the Asus Transformer Prime, and the HP Touchpad).

Referring again to FIG. 7B, operation 720 may include operation 722 depicting obtaining, for each discrete interface device from which subtask result data is received, device information data from the discrete interface device. For example, FIG. 3 shows each discrete interface device from which data was received device information obtaining module 322 obtaining, for each discrete interface device from which subtask data is received (e.g., image data from the picture taken at Times Square) device information data (e.g., identifying information regarding the device or the user of the device, or of a status or characteristic of the device) from the discrete interface device.

Referring again to FIG. 7B, operation 722 may include operation 724 depicting obtaining, for each discrete interface device from which subtask result data is received, device information data identifying the discrete interface device. For example, FIG. 3 shows each discrete interface device from which data was received device identifying information obtaining module 324 obtaining, for each discrete interface device (e.g., the Samsung Galaxy Tab) from which subtask data is received (e.g., image data from the picture taken at Times Square) device information data identifying the discrete interface device (e.g., “the device that collected this information is a Samsung Galaxy Tab”).

Referring again to FIG. 7B, operation 720 may include operation 726 depicting obtaining device information data corresponding to information regarding the two or more discrete interface devices that is packaged with the subtask result data. For example, FIG. 3 shows discrete interface devices from which data was received device information packaged with result data obtaining module 326 obtaining device information data (e.g., identifying information regarding the device or the user of the device, or of a status or characteristic of the device) corresponding to information regarding the two or more discrete interface devices (e.g., the Samsung Epic 4G and the Motorola Brute) that is packaged with the subtask result data (e.g., the received data may take the form of “the Samsung Epic 4G collected the following image data: [data] and the Motorola Brute collected the following image data: [data]). Additional information may be included.

Referring again to FIG. 7B, operation 720 may include operation 728 depicting obtaining device information data corresponding to information regarding the two or more discrete interface devices separately from obtaining the subtask result data. For example, FIG. 3 shows discrete interface devices from which data was received device information obtaining separately from subtask result data module 328 obtaining device information data (e.g., identifying information regarding the device or the user of the device, or of a status or characteristic of the device) corresponding to information regarding the two or more discrete interface devices (e.g., the Samsung Epic 4G and the HTC Evo 3D) separately from obtaining the subtask result data (e.g., the device information data is sent from a different place, or at a different time, or received at a different unit or with a different communication protocol).

Referring again to FIG. 7B, operation 720 may include operation 730 depicting obtaining device information data corresponding to information regarding the two or more discrete interface devices at a different time from obtaining the subtask result data. For example, FIG. 3 shows discrete interface devices from which data was received device information obtaining at different time from subtask result data module 330 obtaining device information data (e.g., identifying information regarding the device or the user of the device, or of a status or characteristic of the device) corresponding to information regarding the two or more discrete interface devices (e.g., the BlackBerry Torch and the Motorola Droid Razr) at a different time from obtaining the subtask result data.

Referring now to FIG. 7C, operation 504 may include operation 732 depicting obtaining subtask result data corresponding to a result of the one or more subtasks carried out by two or more discrete interface devices, from one or more first sources. For example, FIG. 3 shows subtask result data corresponding to a result of one or more interface device carried-out subtasks obtaining from first source module 332 obtaining subtask result data (e.g., image data) corresponding to a result of the one or more subtasks (e.g., “take a picture of Times Square at midnight on New Years' Eve”) carried out by two or more discrete interface devices (e.g., the HTC Evo Flyer and the Apple iPod), from one or more first sources (e.g., the interface devices themselves).

Referring again to FIG. 7C, operation 504 may further include operation 734 depicting obtaining device information data corresponding to information regarding the two or more discrete interface devices, from one or more second sources. For example, FIG. 3 shows discrete interface devices from which data was received device information obtaining from second source module 334 obtaining device information data (e.g., identifying information regarding the device or the user of the device, or of a status or characteristic of the device, e.g., “this is an HTC Flyer located at 45.42352 degrees longitude and −55.15433 degrees latitude) corresponding to information regarding the two or more discrete interface devices (e.g., the HTC Amaze and the BlackBerry Bold), from one or more second sources (e.g., from a service provider, e.g., Facebook, or Google Services, or Apple's App Store).

Referring again to FIG. 7C, operation 734 may include operation 736 depicting obtaining device information data corresponding to information regarding the two or more discrete interface devices, from one or more discrete interface devices. For example, FIG. 3 shows discrete interface devices from which data was received device information obtaining from discrete interface device module 336 obtaining device information data (e.g., identifying information regarding the device or the user of the device, or of a status or characteristic of the device, e.g., “this is a Nook Color Serial Number 0134513-35135”) corresponding to information regarding the two or more discrete interface devices (e.g., the Nook Color and the Sony Tablet S), from one or more discrete interface devices (e.g., the Nook Color and the Sony Tablet S send information about themselves.

Referring again to FIG. 7C, operation 736 may include operation 738 depicting obtaining, for each discrete interface device from which subtask result data is received, device information data corresponding to the discrete interface device, from the respective discrete interface device. For example, FIG. 3 shows each discrete interface devices from which data was received device information obtaining from respective discrete interface device module 338 obtaining, for each discrete interface device (e.g., the Apple iPhone 4) from which subtask result data (e.g., loudness data) is received, device information data (e.g., “This is an iPhone 4 with a microphone) corresponding to the discrete interface device, from the respective discrete interface device (e.g., the iPhone 4).

Referring again to FIG. 7C, operation 734 may include operation 740 depicting obtaining device information data corresponding to information regarding the two or more discrete interface devices, from a provider of a communication network used by at least one of the discrete interface devices. For example, FIG. 3 shows discrete interface devices from which data was received device information obtaining from communication network provider module 340 obtaining device information data (e.g., identifying information regarding the device or the user of the device, or of a status or characteristic of the device, e.g., “this is a Nook Color owned by John Smith DOB Nov. 3, 1954”) corresponding to information regarding the two or more discrete interface devices (e.g., a Nook Color and a Kindle Fire), from a provider of a communication network used by at least one of the discrete interface devices (e.g., a Starbucks-run wireless network that requires users to identify themselves prior to using the wireless network).

Referring again to FIG. 7C, operation 734 may include operation 742 depicting obtaining device information data corresponding to information regarding the two or more discrete interface devices, from a service provider configured to provide a service to at least one of the discrete interface devices. For example, FIG. 3 shows discrete interface devices from which data was received device information obtaining from service provider module 342 obtaining device information data (e.g., identifying information regarding the device or the user of the device, or of a status or characteristic of the device, e.g., “this device has a camera”) corresponding to information regarding the two or more discrete interface devices (e.g., a Samsung Galaxy Nexus and a T-Mobile MyTouch) corresponding to information regarding the two or more discrete interface devices, from a service provider (e.g., Twitter) configured to provide a service to at least one of the discrete interface devices (e.g., the T-Mobile MyTouch has live updating to twitter and pushes messages from Twitter).

Referring again to FIG. 7C, operation 742 may include operation 744 depicting obtaining device information data corresponding to information regarding the two or more discrete interface devices, from a social networking service provider to which at least one of the discrete interface devices is a subscriber. For example, FIG. 3 shows discrete interface devices from which data was received device information obtaining from subscribed social networking provider module 344 obtaining device information data (e.g., identifying information regarding the device or the user of the device, or of a status or characteristic of the device, e.g., “this device has a camera”) corresponding to information regarding the two or more discrete interface devices (e.g., a Samsung Galaxy Nexus and a T-Mobile MyTouch) corresponding to information regarding the two or more discrete interface devices, from a social networking service provider (e.g., Facebook or MySpace) to which at least one of the discrete interface devices is a subscriber (e.g., the owner of the Samsung Galaxy Nexus has a Facebook account that he has accessed through the Nexus).

Referring again to FIG. 7C, operation 742 may include operation 746 depicting obtaining device information data corresponding to information regarding the two or more discrete interface devices, from a microblogging service provider to which at least one of the discrete interface devices is a user. For example, FIG. 3 shows discrete interface devices from which data was received device information obtaining from user microblogging provider module 346 obtaining device information data (e.g., identifying information regarding the device or the user of the device, or of a status or characteristic of the device, e.g., “this device has a camera”) corresponding to information regarding the two or more discrete interface devices (e.g., a Samsung Galaxy Tab and a T-Mobile MyTouch) corresponding to information regarding the two or more discrete interface devices, from a microblogging service provider (e.g., Twitter) to which at least one of the discrete interface devices is a user (e.g., the T-Mobile MyTouch has live updating to twitter and pushes messages from Twitter).

Referring now to FIG. 7D, operation 734 may include operation 748 depicting obtaining device information data corresponding to information regarding the two or more discrete interface devices, from one or more providers of a discrete interface device operating system used by at least one of the two or more discrete interface devices. For example, FIG. 3 shows discrete interface devices from which data was received device information obtaining from discrete interface device operating system provider module 348 obtaining device information data corresponding to information regarding the two or more discrete interface devices, from one or more providers of a discrete interface device operating system (e.g., Google, e.g., Android, or Microsoft, e.g., Windows).

Referring again to FIG. 7D, operation 504 may include operation 752 depicting obtaining subtask result data corresponding to a result of the one or more subtasks carried out by two or more discrete interface devices, from one or more first sources. For example, FIG. 3 shows subtask result data first source module obtaining module 352 obtaining subtask result data corresponding to a result of the one or more subtasks carried out by two or more discrete interface devices (e.g., HTC Rezound and BlackBerry Bold), from one or more first sources (e.g., the discrete interface devices).

Referring again to FIG. 7D, in embodiments in which operation 504 includes operation 752, operation 504 also may include operation 754 depicting obtaining device information data corresponding to information regarding the two or more discrete interface devices, from one or more second sources that are unrelated to the one or more first sources. For example, FIG. 3 shows discrete interface device information obtaining from unrelated second source module 354 obtaining device information data corresponding to information regarding the two or more discrete interface devices (e.g., the HTC Evo 3D and the BlackBerry Bold), from one or more second sources (e.g., Facebook or Verizon Wireless) that are unrelated to the one or more first sources.

Referring again to FIG. 7D, in embodiments in which operation 504 includes operation 752, operation 504 also may include operation 756 depicting obtaining device information data corresponding to information regarding the two or more discrete interface devices, from one or more second sources that are related to the one or more first sources. For example, FIG. 3 shows discrete interface device information obtaining from related second source module 356 obtaining device information data corresponding to information regarding the two or more discrete interface devices (e.g., the HTC Evo 3D and the BlackBerry Bold), from one or more second sources (e.g., Facebook, where the users of the Evo and the Bold are members of Facebook, or Sprint, where the users are communicating via Sprint's 4G WiMax network) that are related to the one or more first sources.

Referring now to FIG. 7E, operation 504 may include operation 760 depicting obtaining subtask result data corresponding to a result of the one or more subtasks carried out by two or more discrete interface devices, from one or more first sources. For example, FIG. 3 shows subtask result data corresponding to a result of carried-out subtasks obtaining from first source module 360 obtaining subtask result data (e.g., image data) corresponding to a result of the one or more subtasks (e.g., “take a picture of Times Square”) carried out by two or more discrete interface devices (e.g., Apple iPhone 4 and Samsung Galaxy Tablet), from one or more first sources (e.g., the discrete interface devices).

Referring again to FIG. 7E, operation 504 may further include operation 762 depicting obtaining device information data corresponding to information regarding the plurality of discrete interface devices, including the two or more discrete interface devices, from one or more second sources. For example, FIG. 3 shows inclusive plurality of discrete interface devices information obtaining from second source module 362 obtaining device information data corresponding to information regarding the plurality of discrete interface devices (e.g., an Apple iPhone 4, a Samsung Galaxy Tablet, a Pantech Breakout, Samsung Epic Touch, HP Touchpad, Microsoft Zune, Sandisk Sansa Clip+, Kodak Playsport, Asus EeePc, Dell Inspiron 15R laptop, ADT Networked Home Security System, Accuweather Weather Station, Chevy Tahoe with OnStar, TomTom GPS 4100, and others), from one or more second sources (e.g., a provider of the wireless network, e.g. Verizon).

Referring again to FIG. 7E, operation 762 may include operation 764 obtaining device information data corresponding to information regarding the plurality of discrete interface devices, including the two or more discrete interface devices, from one or more second sources having a lack of identification of which of the plurality of discrete interface devices are the two or more discrete interface devices. For example, FIG. 3 shows inclusive plurality of discrete interface devices information obtaining from unidentified information second source module 364 obtaining device information data corresponding to information regarding the plurality of discrete interface devices (e.g., an Apple iPhone 4, a Samsung Galaxy Tablet, a Pantech Breakout, Samsung Epic Touch, HP Touchpad, Microsoft Zune, Sandisk Sansa Clip+, Kodak Playsport, Asus EeePc, Dell Inspiron 15R laptop, ADT Networked Home Security System, Accuweather Weather Station, Chevy Tahoe with OnStar, TomTom GPS 4100, and others), from one or more second sources (e.g., Verizon) having a lack of identification of which of the plurality of the discrete interface devices are the two or more discrete interface devices (e.g., Verizon sends all of the device information data for the above devices and does not know that it is the Samsung Galaxy Tablet and Apple iPhone 4 that are the devices from which subtask result data was received.

Referring now to FIG. 7F, operation 504 may include operation 770 depicting obtaining subtask result data corresponding to a result of the one or more subtasks carried out by two or more discrete interface devices. For example, FIG. 3 shows subtask result data from carried out subtasks obtaining module 370 obtaining subtask result data corresponding to a result of the one or more subtasks (e.g., “take a picture of Times Square”) carried out by two or more discrete interface devices.

Referring again to FIG. 7F, operation 504 may further include operation 772 depicting obtaining device information data corresponding to information regarding at least one property of the two or more discrete interface devices. For example, FIG. 3 shows discrete interface devices from which data was received device property information obtaining module 372 obtaining device information data (e.g., information regarding the device) corresponding to information regarding at least one property of the two or more discrete interface devices (e.g., the Samsung Galaxy Nexus and the BlackBerry Torch).

Referring again to FIG. 7F, operation 772 may include operation 774 depicting obtaining device information data corresponding to information regarding a condition present when each of the two or more discrete interface devices carried out the one or more subtasks. For example, FIG. 3 shows discrete interface devices from which data was received device condition present information obtaining module 374 obtaining device information data corresponding to information regarding a condition present (e.g., a position of the discrete interface device) when each of the two or more discrete interface devices (E.g., the Samsung Galaxy Nexus and the BlackBerry Torch) carried out the one or more subtasks (e.g., “take a picture of Times Square”).

Referring again to FIG. 7F, operation 774 may include operation 776 depicting obtaining device information data corresponding to information regarding a position of the discrete interface device when the discrete interface device carried out the one or more subtasks. For example, FIG. 3 shows discrete interface devices from which data was received device position information obtaining module 376 obtaining device information data corresponding to information regarding a position of the discrete interface device (e.g., the BlackBerry Torch) when the discrete interface device carried out the one or more subtasks (e.g., “determine the loudness level at your seat during the Pearl Jam concert”)

Referring again to FIG. 7F, operation 772 may include operation 778 depicting obtaining device information data corresponding to information regarding a time when each of the two or more discrete interface devices carried out the one or more subtasks. For example, FIG. 3 shows discrete interface devices from which data was received device time of carrying out subtask information obtaining module 378 obtaining device information data corresponding to information regarding a time when each of the two or more discrete interface devices (e.g., the Nokia Lumia and the Nokia E7) carried out the one or more subtasks (e.g., “how much rain fell in your location in the last six hours”).

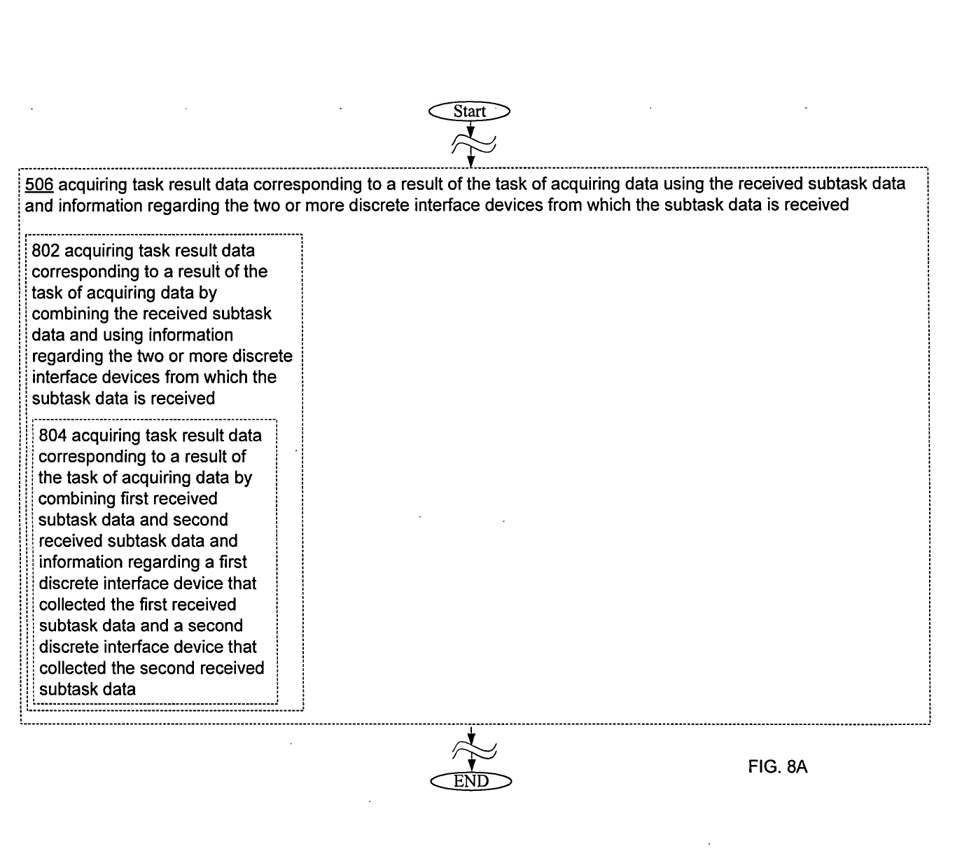

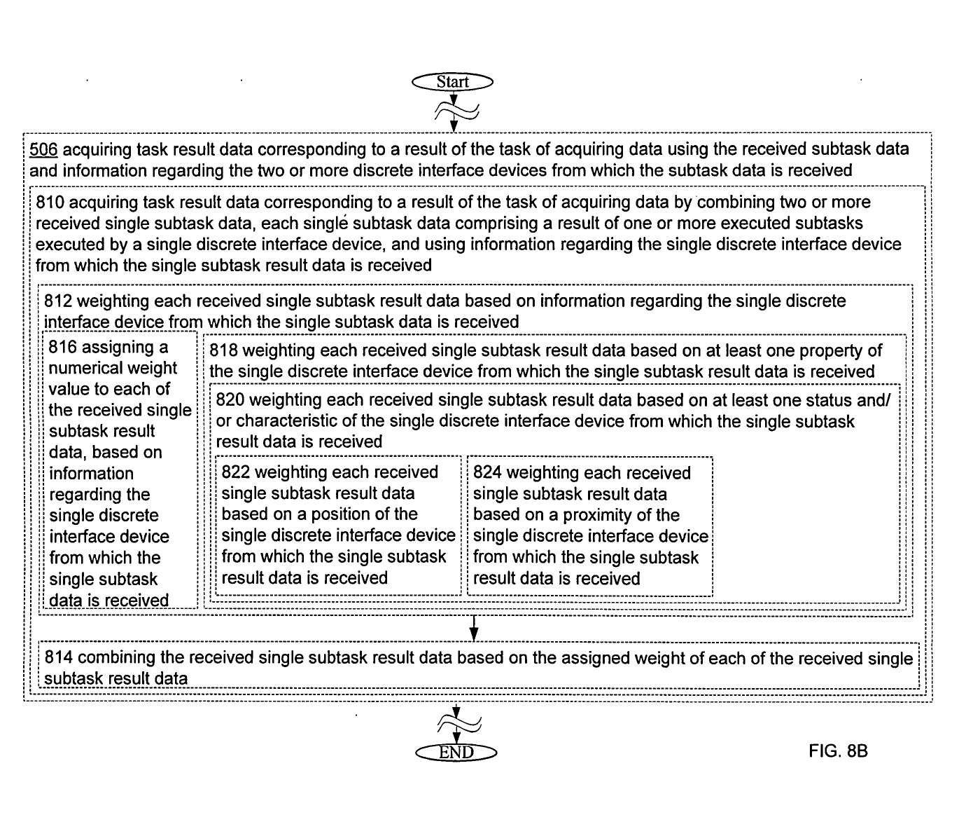

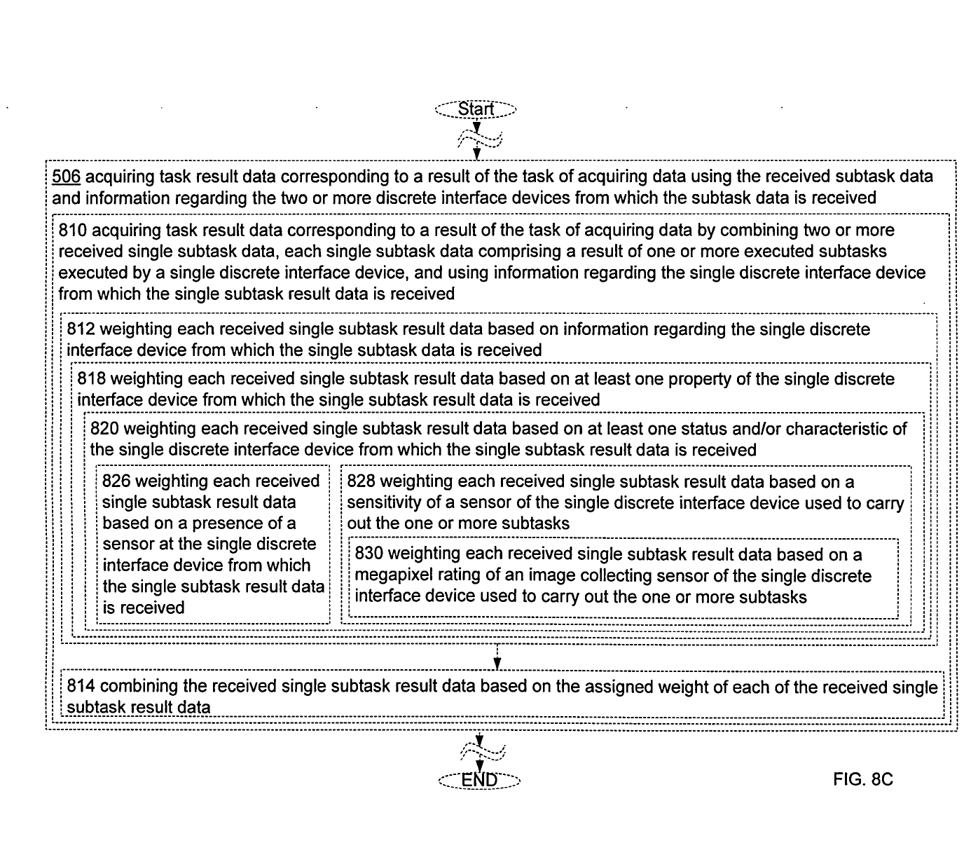

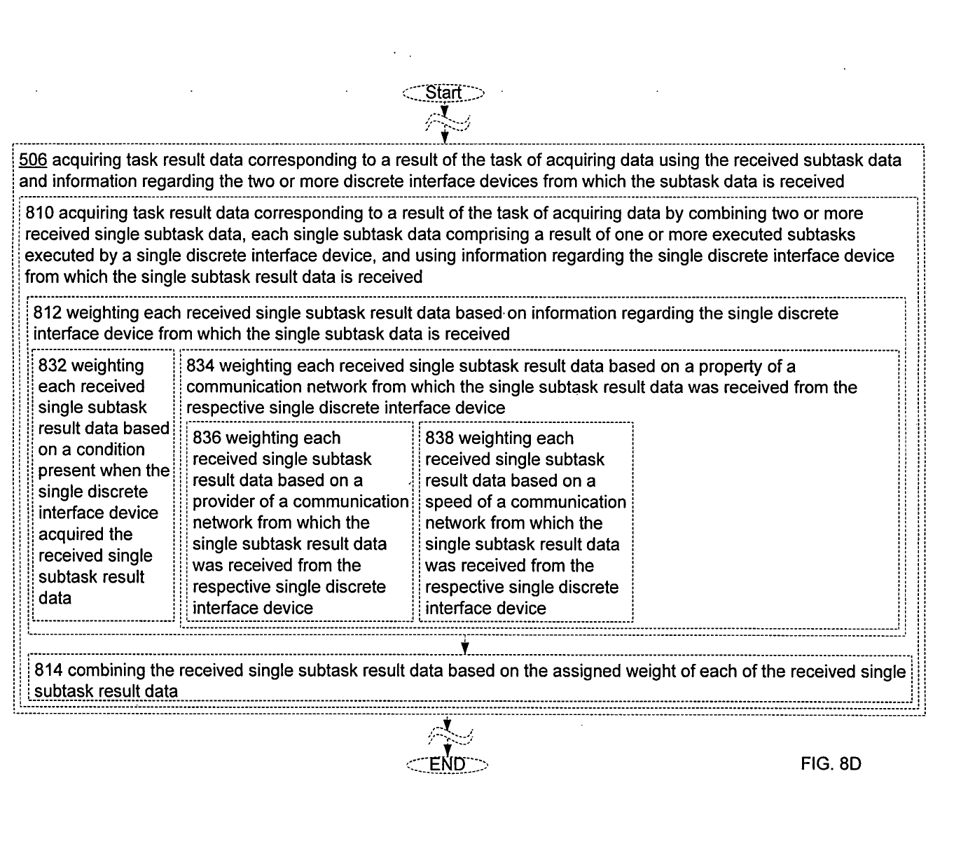

FIGS. 8A-8D depict various implementations of operation 506, according to embodiments. Referring now to FIG. 8A, operation 506 may include operation 802 depicting acquiring task result data corresponding to a result of the task of acquiring data by combining the received subtask data and using information regarding the two or more discrete interface devices from which the subtask data is received. For example, FIG. 4 shows combining received subtask data and using information regarding discrete interface devices task result data acquiring module 402

Referring again to FIG. 8A, operation 802 may include operation 804 depicting acquiring task result data corresponding to a result of the task of acquiring data by combining first received subtask data and second received subtask data and information regarding a first discrete interface device that collected the first received subtask data and a second discrete interface device that collected the second received subtask data. For example, FIG. 4 shows combining first and second received subtask data and using information regarding first and second discrete interface devices task result data acquiring module 404 acquiring task result data (e.g., a 360-degree picture of the Eiffel Tower) corresponding to a result of the task of acquiring data (e.g., obtain a near-real time 360-degree picture of the Eiffel Tower) by combining first received subtask data (e.g., a picture of the Eiffel Tower taken from an iPhone 4) and second received subtask data (e.g., a picture of the Eiffel Tower taken from a Samsung Galaxy Nexus) and information regarding a first discrete interface device (e.g., an iPhone 4) that collected the first received subtask data, and a second discrete interface device (e.g., the Samsung Galaxy Nexus) that collected the second received subtask data.

Referring now to FIG. 8B, operation 506 may include operation 810 depicting acquiring task result data corresponding to a result of the task of acquiring data by combining two or more received single subtask data, each single subtask data comprising a result of one or more executed subtasks executed by a single discrete interface device, and using information regarding the single discrete interface device from which the single subtask result data is received. For example, FIG. 4 shows two or more single subtask data combining and each single discrete interface device information using task result data acquiring module 410 acquiring task result data (e.g., the quietest seat at Merriweather Post Pavilion) corresponding to a result of the task of acquiring data (e.g., determine the quietest seat at Merriweather Post Pavilion) by combining two or more received single subtask data (e.g., loudness data regarding specific places within Merriweather Post Pavilion), each single subtask data comprising a result of one or more executed subtasks (e.g., loudness data) executed by a single discrete interface device (e.g., an iPhone 4) and using information regarding the single discrete interface device (e.g., a property of the discrete interface device) from which the single subtask result data is received.

Referring again to FIG. 8B, operation 810 may include operation 812 depicting weighting each received single subtask result data based on information regarding the single discrete interface device from which the single subtask data is received. For example, FIG. 4 shows received single subtask data weighting module 412 weighting (e.g., placing greater or less emphasis to the data based on various factors), each received single subtask data based on information (e.g., status or characteristic information, or reputation of a user of the interface device), regarding the single discrete interface device (e.g., the HTC Evo 3D) from which the single subtask data is received.

Referring again to FIG. 8B, operation 810 may further include operation 814 depicting combining the received single subtask result data based on the assigned weight of each of the received single subtask result data. For example, FIG. 4 shows weighted received single subtask result data combining module 414 combining the received single subtask result data (e.g., the loudness data measured throughout the concert) based on the assigned weight of each of the received single subtask result data).

Referring again to FIG. 8B, operation 812 may include operation 816 depicting assigning a numerical weight value to each of the received single subtask result data, based on information regarding the single discrete interface device from which the single subtask data is received. For example, FIG. 4 shows received single subtask data numerical weighting module 416 assigning a numerical weight value (e.g., on a scale from 0 to 1, with 1 being perfect weight and 0 being do not consider) to each of the received single subtask result data (e.g., loudness data), based on information regarding the single discrete interface device from which the single subtask data is received (e.g., type of microphone, sensitivity of microphone, location within the theater, previous reliability, duration of data collection, whether the data is an outlier compared to other subtask result data).

Referring again to FIG. 8B, operation 812 may include operation 818 depicting weighting each received single subtask result data based on at least one property of the single discrete interface device from which the single subtask result data is received. For example, FIG. 4 shows received single subtask data interface device property-based weighting module 418 weighting each received single subtask result data (e.g., loudness data) based on at least one property (e.g., microphone sensitivity) of the single discrete interface device (e.g., Sony Personal Recorder) from which the single subtask result data is received.

Referring again to FIG. 8B, operation 818 may include operation 820 depicting weighting each received single subtask result data based on at least one status and/or characteristic of the single discrete interface device from which the single subtask result data is received. For example, FIG. 4 shows received single subtask data interface device status and/or characteristic-based weighting module 420 weighting each received single subtask result data based on at least one status and/or characteristic (e.g., a property) of the single discrete interface device from which the single subtask result data (e.g., loudness data) was received).

Referring again to FIG. 8B, operation 820 may include operation 822 depicting weighting each received single subtask result data based on a position of the single discrete interface device from which the single subtask result data is received. For example, FIG. 4 shows received single subtask data interface device position-based weighting module 422 weighting each received single subtask result data (e.g., image data of the Eiffel Tower”) based on a position of the single discrete interface device (e.g., was the picture taken into the sun, e.g., the lighting from that position) from which the single subtask result data is received.

Referring again to FIG. 8B, operation 820 may include operation 824 depicting weighting each received single subtask result data based on a proximity of the single discrete interface device from which the single subtask result data is received. For example, FIG. 4 shows received single subtask data interface device proximity-based weighting module 424 weighting each received single subtask result data (e.g., speed data regarding highway traffic) based on a proximity of the single discrete interface device (e.g., the TomTom GPS, and its proximity to the center of a traffic delay) from which the single subtask result data is received.

Referring now to FIG. 8C, operation 820 may include operation 826 depicting weighting each received single subtask result data based on a presence of a sensor at the single discrete interface device from which the single subtask result data is received. For example, FIG. 4 shows received single subtask data interface device sensor-based weighting module 826 weighting each received single subtask result data (e.g., wireless network detection numbers) based on a of a presence of a sensor (e.g., a wireless-N radio) at the single discrete interface device (e.g., the iPhone 4) from which the single subtask result data (e.g., “twenty-five wireless networks detected at this position”) is received. The presence of a wireless-N radio gives a more accurate picture of the wireless network coverage, thus this data is given a higher weight, in some embodiments.

Referring again to FIG. 8C, operation 820 may include operation 828 depicting weighting each received single subtask result data based on a sensitivity of a sensor of the single discrete interface device used to carry out the one or more subtasks. For example, FIG. 4 shows received single subtask data interface device sensor sensitivity-based weighting module 828 weighting each received single subtask result data (e.g., loudness data in response to a task of determining how loud the crowd got for opening act The Thermals) based on a sensitivity of a sensor (e.g., microphone sensitivity, which varies greatly across phones and more complex recording equipment) of the single discrete interface device used to carry out the one or more subtasks (e.g. “determine peak loudness at your position when the Thermals come on stage).

Referring again to FIG. 8C, operation 828 may include operation 830 depicting weighting each received single subtask result data based on a megapixel rating of an image collecting sensor of the single discrete interface device used to carry out the one or more subtasks. For example, FIG. 4 shows received single subtask data interface device image sensor pixel rating-based weighting module 430 weighting each received single subtask result data (e.g., image data of Times Square at midnight) based on a megapixel rating of an image collecting sensor of the single discrete interface device used to carry out the one or more subtasks (e.g., the higher the megapixel rating, the more that image will be used to generate the larger image).

Referring now to FIG. 8D, operation 812 may include operation 832 depicting weighting each received single subtask result data based on a condition present when the single discrete interface device acquired the received single subtask result data. For example, FIG. 4 shows received single subtask data condition present based weighting module 432 weighting each received single subtask result data (e.g., image data) based on a condition present (e.g., was the sun shining brightly) when the single discrete interface device (e.g., the Sony PowerShot camera) acquired the received single subtask result data (e.g., the image data from the subtask of “photograph Times Square at noon”).

Referring again to FIG. 8D, operation 812 may include operation 834 depicting weighting each received single subtask result data based on a property of a communication network from which the single subtask result data was received from the respective single discrete interface device. For example, FIG. 4 shows received single subtask data communication network property-based weighting module 434 weighting each received single subtask result data (e.g., rainfall information in response to a subtask of “how much rain fell in your location in the last six hours”) based on a property of a communication network (e.g., whether the communication network is Verizon or Sprint) from which the single subtask result data, e.g., rainfall information, which in this example is not related in any way to the network used to transfer the data) was received from the respective single discrete interface device.

Referring again to FIG. 8D, operation 834 may include operation 836 depicting weighting each received single subtask result data based on a provider of a communication network from which the single subtask result data was received from the respective single discrete interface device. For example, FIG. 4 shows received single subtask data communication network provider-based weighting module 436 weighting each received single subtask result data (e.g., rainfall information in response to a subtask of “how much rain fell in your location in the last six hours”) based on a provider of a communication network (e.g., whether the communication network is Verizon or Sprint) from which the single subtask result data, e.g., Referring again to FIG. 8D, operation 834 may include operation 838 depicting weighting each received single subtask result data based on a speed of a communication network from which the single subtask result data was received from the respective single discrete interface device. For example, FIG. 4 shows received single subtask data communication network speed-based weighting module 438 weighting each received single subtask result data (e.g., image data) based on a speed of a communication network (e.g., the faster the network, the higher the weighting) from which the single subtask result data was received from the respective single discrete interface device.

1. A computationally-implemented method, comprising:
transmitting one or more subtasks corresponding to at least a portion of one or more tasks of acquiring data requested by a task requestor to a plurality of discrete interface devices;
obtaining subtask result data corresponding to a result of the one or more subtasks carried out by two or more discrete interface devices of the plurality of discrete interface devices in an absence of information regarding the task of acquiring data and/or the task requestor; and
acquiring task result data corresponding to a result of the task of acquiring data using the obtained subtask result data and information regarding the two or more discrete interface devices from which the subtask result data is obtained.

2-71. (canceled)

72. A computationally-implemented system, comprising:
means for transmitting one or more subtasks corresponding to at least a portion of one or more tasks of acquiring data requested by a task requestor to a plurality of discrete interface devices;
means for obtaining subtask result data corresponding to a result of the one or more subtasks carried out by two or more discrete interface devices of the plurality of discrete interface devices in an absence of information regarding the task of acquiring data and/or the task requestor; and
means for acquiring task result data corresponding to a result of the task of acquiring data using the obtained subtask result data and information regarding the two or more discrete interface devices from which the subtask result data is obtained.

73. The computationally-implemented system of claim 72, wherein said means for transmitting one or more subtasks corresponding to at least a portion of one or more tasks of acquiring data requested by a task requestor to a plurality of discrete interface devices comprises:
means for transmitting one or more subtasks corresponding to at least a portion of one or more tasks of acquiring data requested by a task requestor to a plurality of discrete interface devices having a particular property.

74. The computationally-implemented system of claim 72, wherein said means for transmitting one or more subtasks corresponding to at least a portion of one or more tasks of acquiring data requested by a task requestor to a plurality of discrete interface devices comprises:
means for transmitting one or more subtasks corresponding to at least a portion of one or more tasks of acquiring data requested by a task requestor to a plurality of discrete interface devices having a particular status and/or characteristic.

75. The computationally-implemented method of claim 74, wherein said transmitting one or more subtasks corresponding to at least a portion of one or more tasks of acquiring data requested by a task requestor to a plurality of discrete interface devices having a particular status and/or characteristic comprises:
means for transmitting one or more subtasks corresponding to at least a portion of one or more tasks of acquiring data requested by a task requestor to a plurality of discrete interface devices having a particular status.

76. (canceled)

77. (canceled)

78. The computationally-implemented method of claim 74, wherein said means for transmitting one or more subtasks corresponding to at least a portion of one or more tasks of acquiring data requested by a task requestor to a plurality of discrete interface devices having a particular status and/or characteristic comprises:
means for transmitting one or more subtasks corresponding to at least a portion of one or more tasks of acquiring data requested by a task requestor to a plurality of discrete interface devices having a particular characteristic.

79. (canceled)

80. (canceled)

81. The computationally-implemented method of claim 72, wherein said means for transmitting one or more subtasks corresponding to at least a portion of one or more tasks of acquiring data requested by a task requestor to a plurality of discrete interface devices comprises:
means for transmitting one or more subtasks corresponding to at least a portion of one or more tasks of acquiring data requested by a service provider to a plurality of discrete interface devices.

82. The computationally-implemented method of claim 81, wherein said means for transmitting one or more subtasks corresponding to at least a portion of one or more tasks of acquiring data requested by a service provider to a plurality of discrete interface devices comprises:
means for transmitting one or more subtasks corresponding to at least a portion of one or more tasks of acquiring data requested by a service provider to a plurality of discrete interface devices having a relationship with the service provider.

83. The computationally-implemented method of claim 82, wherein said means for transmitting one or more subtasks corresponding to at least a portion of one or more tasks of acquiring data requested by a service provider to a plurality of discrete interface devices having a relationship with the service provider comprises:
means for transmitting one or more subtasks corresponding to at least a portion of one or more tasks of acquiring data requested by a service provider to a plurality of discrete interface devices that are subscribers to a service provided by the service provider.

84. The computationally-implemented method of claim 82, wherein said means for transmitting one or more subtasks corresponding to at least a portion of one or more tasks of acquiring data requested by a service provider to a plurality of discrete interface devices having a relationship with the service provider comprises:
means for transmitting one or more subtasks corresponding to at least a portion of one or more tasks of acquiring data requested by a service provider to a plurality of discrete interface devices that are members of a service provided by the service provider.

85. The computationally-implemented method of claim 84, wherein said means for transmitting one or more subtasks corresponding to at least a portion of one or more tasks of acquiring data requested by a service provider to a plurality of discrete interface devices that are members of a service provided by the service provider comprises:
means for transmitting one or more subtasks corresponding to at least a portion of one or more tasks of acquiring data requested by a social networking service provider to a plurality of discrete interface devices that are members of a social networking service provided by the social networking service provider.

86. (canceled)

87. (canceled)

88. (canceled)

89. The computationally-implemented method of claim 72, wherein said means for transmitting one or more subtasks corresponding to at least a portion of one or more tasks of acquiring data requested by a task requestor to a plurality of discrete interface devices comprises:
means for acquiring a list of discrete interface devices; and
means for transmitting one or more subtasks corresponding to at least a portion of one or more tasks of acquiring data requested by a task requestor to a plurality of discrete interface devices that appear on the list of discrete interface devices.

90. (canceled)

91. (canceled)

92. (canceled)

93. The computationally-implemented method of claim 89, wherein said means for acquiring a list of discrete interface devices comprises:
means for retrieving a list of discrete interface devices.

94. (canceled)

95. (canceled)

96. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices of the plurality of discrete interface devices with incomplete information regarding the task of acquiring data and/or the task requestor.

97. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices of the plurality of discrete interface devices with less information than would be present on a device carrying out the task of acquiring data.

98. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices of the plurality of discrete interface devices with insufficient information to carry out the task of acquiring data.

99. (canceled)

100. (canceled)

101. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices of the plurality of discrete interface devices in an absence of information regarding an objective of the task requestor.

102. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices of the plurality of discrete interface devices in an absence of information regarding a purpose of the at least one task.

103. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for receiving subtask result data corresponding to a result of the one or more subtasks carried out by two or more discrete interface devices of the plurality of discrete interface devices in an absence of information regarding the task of acquiring data and/or the task requestor.

104. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices; and
means for obtaining device information data corresponding to information regarding the two or more discrete interface devices.

105. The computationally-implemented method of claim 104, wherein said means for obtaining device information data corresponding to information regarding the two or more discrete interface devices comprises:
means for obtaining, for each discrete interface device from which subtask result data is received, device information data from the discrete interface device.

106. (canceled)

107. (canceled)

108. The computationally-implemented method of claim 104, wherein said means for obtaining device information data corresponding to information regarding the two or more discrete interface devices comprises:
means for obtaining device information data corresponding to information regarding the two or more discrete interface devices separately from obtaining the subtask result data.

109. The computationally-implemented method of claim 104, wherein said means for obtaining device information data corresponding to information regarding the two or more discrete interface devices comprises:
means for obtaining device information data corresponding to information regarding the two or more discrete interface devices at a different time from obtaining the subtask result data.

110. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices, from one or more first sources; and
obtaining device information data corresponding to information regarding the two or more discrete interface devices, from one or more second sources.

111. The computationally-implemented method of claim 110, wherein said means for obtaining device information data corresponding to information regarding the two or more discrete interface devices, from one or more second sources comprises:
means for obtaining device information data corresponding to information regarding the two or more discrete interface devices, from one or more discrete interface devices.

112. The computationally-implemented method of claim 111, wherein said means for obtaining device information data corresponding to information regarding the two or more discrete interface devices, from one or more discrete interface devices comprises:
means for obtaining, for each discrete interface device from which subtask result data is received, device information data corresponding to the discrete interface device, from the respective discrete interface device.

113. The computationally-implemented method of claim 110, wherein said means for obtaining device information data corresponding to information regarding the two or more discrete interface devices, from one or more second sources comprises:
means for obtaining device information data corresponding to information regarding the two or more discrete interface devices, from a provider of a communication network used by at least one of the discrete interface devices.

114. (canceled)

115. (canceled)

116. (canceled)

117. (canceled)

118. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices, from one or more first sources.

119. The computationally-implemented method of claim 118, wherein said means for obtaining subtask result data corresponding to a result of the one or more subtasks carried out by two or more discrete interface devices of the plurality of discrete interface devices in an absence of information regarding the task of acquiring data and/or the task requestor further comprises:
means for obtaining device information data corresponding to information regarding the two or more discrete interface devices, from one or more second sources that are unrelated to the one or more first sources.

120. The computationally-implemented method of claim 118, wherein said means for obtaining subtask result data corresponding to a result of the one or more subtasks carried out by two or more discrete interface devices of the plurality of discrete interface devices in an absence of information regarding the task of acquiring data and/or the task requestor further comprises:
means for obtaining device information data corresponding to information regarding the two or more discrete interface devices, from one or more second sources that are related to the one or more first sources.

121. (canceled)

122. (canceled)

123. The computationally-implemented method of claim 72, wherein said means for obtaining subtask result data corresponding to a result of the one or more subtasks carried out by two or more discrete interface devices of the plurality of discrete interface devices in an absence of information regarding the task of acquiring data and/or the task requestor comprises:
means for obtaining subtask result data corresponding to a result of the one or more subtasks carried out by two or more discrete interface devices; and
means for obtaining device information data corresponding to information regarding at least one property of the two or more discrete interface devices.

124. The computationally-implemented method of claim 123, wherein said means for obtaining device information data corresponding to information regarding at least one property of the two or more discrete interface devices comprises:
means for obtaining device information data corresponding to information regarding a condition present when each of the two or more discrete interface devices carried out the one or more subtasks.

125. The computationally-implemented method of claim 124, wherein said means for obtaining device information data corresponding to information regarding a condition present when each of the two or more discrete interface devices carried out the one or more subtasks comprises:
means for obtaining device information data corresponding to information regarding a position of the discrete interface device when the discrete interface device carried out the one or more subtasks.

126. (canceled)

127. The computationally-implemented method of claim 72, wherein said means for acquiring task result data corresponding to a result of the task of acquiring data using the obtained subtask result data and information regarding the two or more discrete interface devices from which the subtask result data is obtained comprises:
means for acquiring task result data corresponding to a result of the task of acquiring data by combining the received subtask data and using information regarding the two or more discrete interface devices from which the subtask data is received.

128. The computationally-implemented method of claim 127, wherein said means for acquiring task result data corresponding to a result of the task of acquiring data by combining the received subtask data and using information regarding the two or more discrete interface devices from which the subtask data is received comprises:
means for acquiring task result data corresponding to a result of the task of acquiring data by combining first received subtask data and second received subtask data and information regarding a first discrete interface device that collected the first received subtask data and a second discrete interface device that collected the second received subtask data.

129. The computationally-implemented method of claim 72, wherein said means for acquiring task result data corresponding to a result of the task of acquiring data using the obtained subtask result data and information regarding the two or more discrete interface devices from which the subtask result data is obtained comprises:
means for acquiring task result data corresponding to a result of the task of acquiring data by combining two or more received single subtask data, each single subtask data comprising a result of one or more executed subtasks executed by a single discrete interface device, and using information regarding the single discrete interface device from which the single subtask result data is received.

130. The computationally-implemented method of claim 129, wherein said means for acquiring task result data corresponding to a result of the task of acquiring data by combining two or more received single subtask data, each single subtask data comprising a result of one or more executed subtasks executed by a single discrete interface device, and using information regarding the single discrete interface device from which the single subtask result data is received comprises:
means for weighting each received single subtask result data based on information regarding the single discrete interface device from which the single subtask data is received; and
means for combining the received single subtask result data based on the assigned weight of each of the received single subtask result data.

131. (canceled)

132. The computationally-implemented method of claim 130, wherein said means for weighting each received single subtask result data based on information regarding the single discrete interface device from which the single subtask data is received comprises:
means for weighting each received single subtask result data based on at least one property of the single discrete interface device from which the single subtask result data is received.

133. The computationally-implemented method of claim 132, wherein said means for weighting each received single subtask result data based on at least one property of the single discrete interface device from which the single subtask result data is received comprises:
means for weighting each received single subtask result data based on at least one status and/or characteristic of the single discrete interface device from which the single subtask result data is received.

134. The computationally-implemented method of claim 133, wherein said means for weighting each received single subtask result data based on at least one status and/or characteristic of the single discrete interface device from which the single subtask result data is received comprises:
means for weighting each received single subtask result data based on a position of the single discrete interface device from which the single subtask result data is received.

135. (canceled)

136. (canceled)

137. The computationally-implemented method of claim 133, wherein said means for weighting each received single subtask result data based on at least one status and/or characteristic of the single discrete interface device from which the single subtask result data is received comprises:
means for weighting each received single subtask result data based on a sensitivity of a sensor of the single discrete interface device used to carry out the one or more subtasks.

138. (canceled)

139. The computationally-implemented method of claim 130, wherein said means for weighting each received single subtask result data based on information regarding the single discrete interface device from which the single subtask data is received comprises:
means for weighting each received single subtask result data based on a condition present when the single discrete interface device acquired the received single subtask result data.

140. The computationally-implemented method of claim 130, wherein said means for weighting each received single subtask result data based on information regarding the single discrete interface device from which the single subtask data is received comprises:
means for weighting each received single subtask result data based on a property of a communication network from which the single subtask result data was received from the respective single discrete interface device.

141. (canceled)

142. (canceled)

143. (canceled)

144. (canceled)
